(19) United States
(12) Patent Application Publication
(10) Pub. No.: US 2022/0274062 A1
(43) Pub. Date: Sep. 1, 2022

(54) SYSTEM AND METHOD FOR PROCESSING AND CONCENTRATING SELECTED IONS IN BRINE SOLUTIONS

(71) Applicant: SUMMIT NANOTECH CORPORATION, Calgary (CA)

(72) Inventors: Drew Adrian Moxon, Calgary (CA); Ryan Kraft, Calgary (CA); Amanda Hall, Calgary (CA); Amir Ahmadian, Calgary (CA); Kelly Krahulic, Calgary (CA)

(73) Assignee: SUMMIT NANOTECH CORPORATION, Calgary, AB (CA)

(21) Appl. No.: 17/622,775

(22) PCT Filed: Jun. 26, 2020
(86) PCT No.: PCT/CA2020/050887

§ 371 Date: Dec. 24, 2021

Related U.S. Application Data
(60) Provisional application No. 62/867,429, filed on Jun. 27, 2019.

(51) Int. Cl. B01D 61/00; B01D 61/58; B01D 15/08; C02F 9/00; C22B 3/24; C22B 26/12; C01D 15/08

(52) U.S. Cl. CPC B01D 61/005; B01D 61/58; B01D 15/08; C02F 9/00; C22B 3/24; C22B 26/12; C01D 15/08; B01D 2311/04; B01D 2311/2626; B01D 2317/02; C02F 2101/20

(57) ABSTRACT

An apparatus and method for recovering metal from a solution comprising a metal-selective sorbent disposed in a column. Additional embodiments provide for using a metal-selective membrane configured for selective transport, isolation, retention, and recovery of metal ions and compounds; electrodialysis and forward osmosis apparatuses to recover metal from a solution. A modular system to process a solution at a remote field site is disclosed. The process is a green process and produces limited to no industrial waste.

### CROSS-REFERENCE TO RELATED APPLICATIONS

This application claims priority to and the benefit of the filing of U.S. Provisional Patent Application No. 62/867,429, entitled “System and Method for Processing and Concentrating Selected Ions in Brine Solutions,” filed on Jun. 27, 2019, and the specification thereof is incorporated herein by reference.

### TECHNICAL FIELD

Various embodiments disclosed herein generally relate to the recovery of heavy metal ions and compounds from solutions. More specifically, this disclosure pertains to apparatuses, systems, and methods for extracting and recovering metal from brine solutions.

### BACKGROUND OF THE INVENTION

High-value metals are used in the manufacture of ceramics, glass, lubricants, light-weight alloys, medicines, and batteries. For example, lithium (Li)-based batteries have become well known for their capacity to store considerable electrical energy that can be used to power electronic devices for extended periods of time. The development of Li-based batteries for powering electric vehicles has resulted in the rapidly increasing popularity of and commercialization of electric cars and trucks.

Metals are most readily available in naturally occurring brine solutions commonly referred to as continental brines. Metal-rich naturally occurring brine solutions typically contain, in addition to Li and other metals, varying mixtures of cations and anions such as Na, K, Mg, Ca, Cl, SO₄, CO₃, B, Ba, Sr, Br, I, and F.

Numerous technologies have been developed and used commercially for recovery and concentration of metals from brines. Recently, there have been several new approaches disclosed for metal recovery including development and use of solid particulate compositions for extracting metal salts from brines. In this process, the solid particle compositions comprise a framework structure of X and M(OH)z units, where X is an anionic species that may be a halide, nitrate, sulfate, carbonate, and bicarbonate and M is an oxophilic transition metal atom. The framework structure is used by flowing brine solution containing, for instance, a Li salt through a packed bed of the framework structures. Solid particles are captured by the bed of framework structures and metal salts are recovered. Li, for example, is recovered using an aqueous washing solution containing the Li salt in a concentration of no more than 50% of the concentration of Li salt in the starting brine solution. Other approaches have focused on the precipitation of salts and heavy metals from brines to enrich the concentration of the metal in the treated brines.

Traditional metal extraction processes are problematic because they are expensive, require the use of large volumes of fresh water, require the handling and disposal of large volumes of chemical waste, emit large volumes of CO2 into the atmosphere, and their recovery factors are often less than 50%.

### SUMMARY

The embodiments of the present disclosure generally relate to apparatuses, systems, and methods for the concentration and recovery of metal from solution. The solution may be brine solutions recovered from naturally occurring continental brine deposits. The solution may also be from fluid brine suspensions produced from hydraulic mining operations of geological formation solid deposits of lithium or other metals therein and/or from brines and wastewater produced from oil and gas production activities. The solution may also be a brine feedstock. The solution may also be any liquid or liquid-like substance comprising a metal.

In one embodiment, the present disclosure relates to a method for recovering at least one metal from a solution comprising: contacting the solution with a metal-selective sorbent, wherein the metal-selective sorbent is packed in at least one column; sorbing the at least one metal onto the metal-selective sorbent to form a metal-sorbent complex; and contacting the metal-sorbent complex with an eluant solution to form a metal eluate.

In another embodiment, the method further comprises pretreating the solution. In another embodiment, the method further comprises contacting the metal eluate with a metal-selective membrane. In another embodiment, the metal-selective membrane comprises a metal organic framework. In another embodiment, the metal-selective membrane comprises ion-conductive pores. In another embodiment, the metal-selective membrane comprises embedded metal ions. In another embodiment, the metal-selective membrane comprises sub-nanometer dehydrating pores. In another embodiment, the sub-nanometer dehydrating pores are uniform.

In another embodiment, the method further comprises contacting the metal eluate with a forward osmosis membrane. In another embodiment, the method further comprises contacting the metal eluate with a draw solution. In another embodiment, the draw solution generates osmotic pressure. In another embodiment, the method further comprises contacting the forward osmosis membrane with ammonium carbonate. In another embodiment, the method further comprises decomposing ammonium bicarbonate to NH₃, CO₂, and H₂O. In another embodiment, decomposing ammonium bicarbonate occurs at a temperature greater than approximately 35° C.

In another embodiment, the method further comprises recycling HN₄Cl and CaO waste from the metal eluate through a method comprising: converting HN₄Cl and CaO to a NH₃, CaCl₂ and H₂O solution; separating the NH₃, CaCl₂ and H₂O solution into an NH₃ gas, a CaCl₂ solution, and water; hydrating the NH₃ gas to form ammonia water; carbonating the ammonia water to form an ammonia carbonate compound; and conveying the ammonia carbonate compound to the forward osmosis membrane. In another embodiment, the method further comprises electro-dialyzing the metal eluate comprising the at least one metal. In another embodiment, the metal eluate comprises a metal chloride compound. In another embodiment, the method further comprises converting the metal chloride compound to a metal carbonate compound. In another embodiment, converting the metal chloride compound to a metal carbonate compound occurs at a temperature no greater than approximately 35° C.

In another embodiment, the present disclosure relates to a method for synthesizing a metal-selective membrane, the method comprising: mixing a metal precursor with a solvent to form a metal precursor solution; mixing a linker with the solvent to form a linker solution; mixing the metal precursor solution with the linker solution to form a membrane solution; recovering metal organic framework (MOF) particles from the membrane solution; and coating the MOF particles onto a substrate.

In another embodiment, the method further comprises precipitating a product from the membrane solution. In another embodiment, the method further comprises separating the product from the membrane solution. In another embodiment, the linker is an organic linker.

In another embodiment, the MOF particles are coated onto the substrate by: suspending the substrate at least partially within a container; and adding the membrane solution to the container to at least partially submerge the substrate in the membrane solution. In another embodiment, the MOF particles are coated onto the substrate by: orienting the substrate in a holder, wherein the substrate comprises a first location and a second location; contacting the first location of the substrate with the metal precursor solution; and contacting the second location of the substrate with the linker solution. In another embodiment, the MOF particles are coated onto the substrate by: at least partially disposing the substrate within a container; fitting a funnel comprising a first open end and second open end, to a substrate, wherein the first open end is fitted to the substrate; and pouring the membrane solution into the second open end of the funnel. In another embodiment, the MOF particles are coated onto the substrate by: at least partially disposing the substrate within a container; mixing the metal precursor solution with dimethyl formamide to form a metal precursor-dimethyl formamide (MP-DF) solution; contacting the substrate with the MP-DF solution to form an MP-DF substrate system at least partially disposed within the container; applying a vacuum to the MP-DF substrate system; increasing the MP-DF-substrate system to a higher temperature; at least partially submerging the MP-DF-substrate system in a solvent; and activating the MP-DF-substrate system. In another embodiment, the vacuum is applied for at least approximately 48 hours.

In another embodiment, the present disclosure relates to a column jacket apparatus for heating a solution entering a column, the column jacket apparatus comprising: an outer surface at least partially enclosing a first cavity space; an inner surface at least partially enclosing a second cavity space, wherein the inner surface is at least partially disposed within the first cavity space; and a solution conveyor at least partially disposed within the first cavity space.

In another embodiment, the apparatus further comprises a column. In another embodiment, the column comprises a first end and a second end. In another embodiment, the second end of the column is in communication with at least one heat exchanger. In another embodiment, the column is in communication with at least one three-way valve.

In another embodiment, the present disclosure relates to an apparatus for concentrating and recovering at least one metal from a solution, the apparatus comprising: a container wherein an interior comprises at least one module for concentrating and recovering the at least one metal; a fluid ingress port; a pre-conditioning module; and a metal extraction module comprising a metal-selective sorbent at least partially disposed within a column.

In another embodiment, the container comprises a standard shipping container. In another embodiment, the apparatus comprises a modular apparatus. In another embodiment, the apparatus further comprises its own power source. In another embodiment, the apparatus further comprises an electro-dialysis module.

In another embodiment, the apparatus further comprises a forward osmosis module. In another embodiment, the forward osmosis module comprises a membrane at least partially disposed within the forward osmosis module. In another embodiment, the forward osmosis module comprises a draw solution partially disposed within the forward osmosis module. In another embodiment, the forward osmosis module comprises a reaction vessel. In another embodiment, the forward osmosis module comprises at least one selective separation unit. In another embodiment, the apparatus further comprises a metal-selective membrane.

In another embodiment, the present disclosure relates to an apparatus for recovering at least one metal from a solution, comprising: a metal-selective membrane comprising: a metal organic framework; sub-nanometer dehydrating pores; embedded metal ions; and a substrate at least partially attached to the metal-selective membrane. In another embodiment, the substrate is carbon-based. In another embodiment, the substrate is an anodic aluminum oxide substrate.

In another embodiment, the present disclosure relates to an apparatus for recovering at least one metal from a solution, the concentrator apparatus comprising: a first filter system for containing a first solution and a second solution, wherein the first filter system comprises a forward osmosis membrane; and a second filter system for containing the second solution and a third solution, wherein the second filter system comprises a metal-selective membrane. In another embodiment, the apparatus further comprises a water source in communication with the second filter system.

In another embodiment, the concentrator apparatus concentrates the first solution at higher concentration than the second solution and the third solution. In another embodiment, the concentrator apparatus concentrates the second solution at lower concentration than the first solution and the third solution. In another embodiment, the concentrator apparatus concentrates the third solution at a higher concentration than the second solution and at a lower concentration than the first solution.

In another embodiment, the present disclosure relates to a loop apparatus for recovering at least one metal from a solution, the loop apparatus comprising: a first basing comprising an inlet and an outlet; a flow regulator; and a loop for flowing solution therethrough and in communication with the basin, the loop comprising a water permeable membrane and a metal-selective membrane. In another embodiment, the apparatus further comprises a second basin in communication with the first basin for receiving the solution. In another embodiment, the water membrane comprises a hollow-fiber membrane. In another embodiment, the second basin is in communication with a third loop. In another embodiment, the first basin and the second basin are conical.

In another embodiment, the metal-selective membrane comprises a zeolitic imidazolate framework. In another embodiment, the metal-selective membrane comprises a UiO-66 framework. In another embodiment, an electric field is applied to the metal-selective membrane. In another embodiment, the metal-selective membrane isolates metal chloride compounds.

In another embodiment, the apparatus has a lamellar orientation comprising: at least one layer of metal organic framework; and another layer comprising the substrate. In another embodiment, the apparatus has a tubular orientation. In another embodiment, the tubular orientation comprises an outer layer comprising the substrate. In another embodiment, the tubular orientation comprises an inner layer comprising the metal organic framework.

### BRIEF DESCRIPTION OF DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic flow chart illustrating a method of metal recovery for a solution using solution pre-treatment, a metal-selective sorbent, nanofiltration by a metal-selective membrane, and solution concentration, according to an embodiment of the present invention;

FIGS. 2A and 2B are schematic flow charts illustrating methods of metal recovery for a solution using solution pre-treatment, a metal-selective sorbent, nanofiltration by a metal-selective membrane, pH elevation, contaminant removal, carbonation, vacuum and heat, electrolysis, filtration, and drying, according to embodiments of the present invention;

FIGS. 3A and 3B are schematic flow charts illustrating methods of metal recovery for a solution using solution pre-treatment, a metal-selective sorbent, electrodialysis, pH elevation, contaminant removal, carbonation, vacuum and heat, electrolysis, filtration, and drying, according to embodiments of the present invention;

FIG. 4 is a schematic flow chart illustrating a method of metal recovery for a solution using solution pre-treatment, a metal-selective sorbent, electrodialysis, pH elevation, contaminant removal, carbonation, vacuum and heat, electrolysis, filtration, and drying, according to an embodiment of the present invention;

FIGS. 5A, 5B, 5C, 5D, 5E, and 5F are schematic flow charts illustrating modular systems for recovering metal from a solution, according to embodiments of the present invention, FIG. 5A illustrating a modular system for recovering metal in an existing carbonate facility with a solution pre-conditioning module, an extraction module with metal-selective sorbent, and a nanofiltration module with a metal-selective membrane, FIGS. 5B and 5F illustrating modular systems for recovering metal with a solution pre-conditioning module, an extraction module with metal-selective sorbent, and a nanofiltration module with a metal-selective membrane, a pre-treatment module, a polishing module, a carbonation module, a hydroxylation module, and a drying module, FIGS. 5C and 5E illustrating modular systems for recovering metal with a solution pre-conditioning module, an extraction module with metal-selective sorbent, and an electrodialysis module, a pre-treatment module, a polishing module, a carbonation module, a hydroxylation module, and a drying module, and FIG. 5D illustrating a modular system for recovering metal with a solution pre-conditioning module, an extraction module with metal-selective sorbent, a forward osmosis module, and a drying module;

FIG. 6 is an illustration from a perspective view of modular systems for recovering metal from a solution with containers and skid mounts for use in remote field operations according to an embodiment of the present invention;

FIG. 7 is an illustration from a perspective view of a metal-selective membrane in a lamellar orientation according to an embodiment of the present invention;

FIG. 8 is an illustration from a perspective view of a metal-selective membrane in a tubular orientation according to an embodiment of the present invention;

FIG. 9 is an illustration of the structural components of a metal-selective membrane, including pores, embedded ions, and a metal organic framework, according to an embodiment of the present invention;

FIG. 10 is a schematic flow chart illustrating a conventional column system for adsorbing lithium or other ions, according to an embodiment of the present invention;

FIG. 11 is a schematic flow chart illustrating a metal sorption column system with a column jacket apparatus to heat liquid entering the columns, the column jacket comprising a space for heated fluid and a liquid conveyor, according to an embodiment of the present invention;

FIG. 12 is a pair of schematic flow charts illustrating heat exchangers for regulating the fluid temperature in a column jacket apparatus, according to an embodiment of the present invention;

FIG. 13 is a pair of schematic flow charts illustrating column jacket apparatuses and columns in combination with three-way valves to provide continuous flow of heated liquid into the columns, according to an embodiment of the present invention;

FIG. 14 is a schematic flow chart illustrating a metal sorption column system using a column jacket apparatus to heat fluid entering the columns in combination with heat exchangers for regulating the fluid temperature in the column jacket apparatus, according to an embodiment of the present invention;

FIGS. 15A, 15B, and 15C are illustrations from a perspective view of conventional columns according to embodiments of the present invention, FIG. 15A illustrating a conventional column where adsorption and elution occur from top to bottom, FIG. 15B illustrating a conventional column where adsorption and elution occur from bottom to top, and FIG. 15C illustrating a conventional column with a removable cap and a space for sorbent material;

FIG. 16 is an illustration of a substrate between frit tunnels, according to an embodiment of the present invention, which also illustrates a method of coating a substrate with a metal-selective membrane by holding a substrate in place and applying a metal precursor solution and a linker solution to each face of the substrate;

FIG. 17 is a schematic flow chart illustrating a method of coating a substrate with a metal-selective membrane by sealing a funnel on top of the substrate and pouring membrane solution into the funnel, according to an embodiment of the present invention;

FIG. 18 is a drawing from a frontal view illustrating a loop apparatus for recovering metal from a solution according to an embodiment of the present invention in which the loop apparatus recovers metal with a forward osmosis membrane and a metal-selective membrane;

FIG. 19 is a drawing from a frontal view illustrating a cascade of loop apparatuses for recovering metal from a solution according to an embodiment of the present invention in which the filtered solution and remaining solution after filtration are further concentrated by entering additional loop apparatuses;

FIG. 20 is a schematic flow chart illustrating a forward osmosis module for chemically converting metal in a solution with a draw solution according to an embodiment of the present invention in which the draw solution provides energy for the chemical conversion through osmotic pressure;

FIG. 21 is a schematic flow chart illustrating a system of metal recovery by forward osmosis with a forward osmosis module according to an embodiment of the present invention in which the system chemically converts metal chlorides to metal carbonates through osmotic pressure from a draw solution and the system also recycles waste into usable starting materials for the forward osmosis module;

FIG. 22 is a schematic flow chart illustrating a system of metal recovery by forward osmosis with a forward osmosis module according to an embodiment of the present invention in which the system chemically converts metal chlorides to metal carbonates through osmotic pressure from a draw solution and in which the system also recycles waste into usable starting materials for the forward osmosis module; and

FIG. 23 is a schematic flow chart illustrating a system of metal recovery by forward osmosis according to an embodiment of the present invention in which a forward osmosis filter is shown in combination with a metal-selective membrane and tanks.

### DETAILED DESCRIPTION

No language or terminology in this specification should be construed as indicating any non-claimed element as essential or critical. All methods described herein can be performed in any suitable order unless otherwise indicated herein. The use of any and all examples, or example language (e.g., “such as”) provided herein, is intended merely to better illuminate example embodiments and does not pose a limitation on the scope of the claims appended hereto unless otherwise claimed.

It should be noted that if the stereochemistry of a structure or a portion of a structure is not indicated with, for example, bold or dashed lines, the structure or the portion of the structure is to be interpreted as encompassing all stereoisomers of it. Moreover, any atom shown in a drawing with unsatisfied valences is assumed to be attached to enough hydrogen atoms to satisfy the valences. In addition, chemical bonds depicted with one solid line parallel to one dashed line encompass both single and double (e.g., aromatic) bonds, if valences permit.

Throughout this specification, the word “comprise”, or variations such as “comprises”, “comprising”, “including”, “containing”, and the like, will be understood to imply the inclusion of a stated element or integer or group of elements or integers but not the exclusion of any other element or integer or group of elements or integers, unless the context requires otherwise.

To facilitate understanding of this example embodiments set forth herein, a number of terms are defined below. Generally, the nomenclature used herein and the laboratory procedures, inorganic chemistry, and organic chemistry described herein are generally well known and commonly employed in the art. Unless defined otherwise, all technical and scientific terms used herein generally have the same meaning as commonly understood in the art to which this disclosure belongs. In the event that there is a plurality of definitions for a term used herein, those in this written description shall prevail unless stated otherwise herein.

As used herein, the singular forms “a”, “an”, and “the,” may also refer to plural articles, i.e., “one or more”, “at least one”, “and/or”, are open-ended expressions that are both conjunctive and disjunctive in operation. For example, the term “a cannabinoid” includes “one or more cannabinoids”. Further, each of the expressions “at least one of A, B, and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The term “an entity” refers to one or more of that entity. As such, the terms “a”, “an”, “one or more”, and “at least one” can be used interchangeably herein.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller subranges are also included. The upper and lower limits of these smaller ranges are also included therein, subject to any specifically excluded limit in the stated range.

The terms “about” or “approximately” as used herein, mean an acceptable error for an articular recited value, which depends in part on how the value is measured or determined. In certain embodiments, “about” can mean one or more standard deviations. When the antecedent term “about” is applied to a recited range or value it denotes an approximation within the deviation in the range or value known or expected in the art from the measurement method. For removal of doubt, it should be understood that any range stated in this written description that does not specifically recite the term “about” before the range or before any value within the stated range inherently includes such term to encompass the approximation within the deviation noted above.

The term “metal” is defined to be an ion of metal or a compound or molecule comprising at least one metal atom. The term “metal” is not limited to a single species of metal (e.g. lithium, titanium, or copper) and is meant to encompass all species of metal ions, compounds, or molecules.

In another embodiment of the present invention, a method of metal recovery from a solution is used to recover solvent metals. A solution is treated with a metal-selective sorbent to isolate lithium and/or other target metals from the other components of the solution. The metal-selective sorbent, which may include AlOx-based sorbents, MnOx-based sorbents, TiOx-based sorbents, and/or organic ionophore-based sorbents (such as crown ethers, phosphonates, carboxylates, metallacrowns, etc.), selectively retains at least one metal while the other components of the solution are drained. The metal-selective sorbents may comprise at least one transition metal atom. Some examples of transition metals include scandium, titanium, vanadium, chromium, manganese, iron, cobalt, nickel, copper, zinc, yttrium, zirconium, and niobium.

The metal-selective sorbent having any of the above compositions is packed in at least one column. The column may be a fixed bed column. The solution flows through the packed bed of sorbents by any suitable means, including in a downflow mode or an upflow mode.

The sorbent sorbs at least one metal in the solution to form a metal-sorbent complex. The sorption process may be adsorption or absorption. The metal-selective sorbent may then be rinsed.

An eluent solution flows into the column and detaches the metal from the metal-sorbent complex. The eluent solution may comprise a dilute salt solution (e.g., lithium chloride, sodium chloride, calcium chloride, magnesium chloride, potassium chloride, sea water, etc.), acid (e.g., HCl, etc.), a bicarbonate salt (e.g., ammonium bicarbonate, sodium bicarbonate, potassium bicarbonate, etc.), a compound that forms a weak bond with lithium, such as an ionophore (e.g., crown ethers, phosphonates, carboxylates, metallacrowns, etc.) containing solvent, and/or any combination of these.

These processes can occur in the temperature ranges of approximately 0° C.-100° C. and at pressures from approximately 1 atm-100 atm. The metal-selective sorbent step may be repeated more than once to recover more metal from a solution. A metal eluate comprising the at least one metal leaves the column and continues to be processed.

The method may include polishing the metal eluate. Polishing may be done through contact with a metal-selective membrane or forward osmosis membrane, or electrodialysis. The method for recovering metal from a solution may include contacting the metal with a metal-selective membrane to form a polished metal solution. The metal-selective membrane may be a nanofilter. The metal-selective membrane incorporates subcomponents configured to isolate and/or concentrate at least one metal from a solution. Additionally, the metal-selective membrane may remove divalent ions. The metal-selective membrane is able to operate at a temperature within the range of approximately 0 to 100° C. and pressures ranging from approximately 1 to 100 atm. Metal-selective membranes may be orientated in parallel and/or in series to ensure adequate waste rejection, metal recovery, and adequate performance at varying flow rates.

The polished metal solution may be further concentrated to form a concentrated metal solution. The concentration of the at least one metal in the concentration may be about 1% to 6% by volume or weight. The metal eluate may also be polished by electrodialysis.

The method for recovering metal from a solution may also include the use of forward osmosis membrane. In this step, the solution may be a dilute metal solution at temperatures ranging from approximately 0° C. to 35° C. flowing towards the forward osmosis membrane. The solution, including at least one metal, is transported across the semi-permeable membrane using osmotic pressure as the driving force. A draw solution provides the osmotic pressure difference to generate enough force to transport at least one metal across the forward osmosis membrane. The forward osmosis membrane may operate co-currently, or counter-currently and may comprise two inlet and outlet streams, the draw solution, and the solution. The draw solution may compromise a bicarbonate salt. The bicarbonate salt may include ammonium bicarbonate, ammonium carbonate, sodium bicarbonate, potassium bicarbonate and/or any combination of these bicarbonate salts. The draw solution provides enough osmotic pressure solution to transfer enough metal for a reaction to occur. The transferred metal may be metal ions or a metal chloride. Taking LiCl as an example, the LiCl in the solution reacts with a carbonate draw solution according to the following reaction(s):

2NH₄HCO₃+2LiCl→Li2CO₃+2NH₄Cl+CO₂+H₂O Eqn. 1

2Li(HCO₃)≈Li₂CO₃+CO₂ Eqn. 2

The reaction(s) presented above may differ slightly based on the draw solution used and contaminants present. The metal carbonate product is generated if carbonate compounds are used for the reaction. Product solutions, including metal carbonate solutions, then move from the forward osmosis membrane to reaction vessel(s) enabling the reaction to proceed to achieve a conversion rate greater than approximately 80%. In the case of a metal chloride, this means an approximately 80% conversion of a metal chloride to a metal carbonate. The solution is then transferred to a set of selective separation units to selectively precipitate the products, including metal carbonates, as a solid slurry for further drying and purification. The separator operates at temperatures greater than approximately 35° C. to cause unreacted bicarbonate to decompose to form gaseous ammonia, carbon dioxide, and water. Gaseous ammonia, carbon dioxide, and water may be recycled to other reactors to regenerate NH₄HCO₃, (NH₄)₂CO₃, or other carbonate compounds. Remaining ammonium chloride may be carried to a final reactor where it proceeds with the following reaction:

2NH₄Cl+CaO→2NH₃+CaCl₂+H₂O Eqn. 3

Following the reactor, the solution may proceed to a final separation system where the calcium chloride is separated from ammonia and water. Ammonia and water are recycled to a final reactor(s) which then feeds NH₄HCO₃, (NH₄)₂CO₃, or other carbonate compounds into an apparatus containing the forward osmosis membrane.

Forward osmosis membranes preferably range in number from 1 to 10, and may be oriented in parallel or in series. In addition, anti-fouling methods, including backflushing, polarity reversal, electromagnets, and/or anti-scalants, may be used to reduce fouling in the forward osmosis membrane. The forward osmosis membranes may be either commercial or proprietary membranes. The forward osmosis membranes may be a flat sheet, spiral wound, or hollow tube orientations. Contacting the solution with the forward osmosis membrane resulting in the above chemical reactions polishes the solution in preparation for additional processing.

The method may include chemical purification steps, including the addition of sufficient amounts of a base (e.g., NaOH, LiOH, KOH, etc.) or acid to achieve pH values of 8-11 at temperatures in the range of approximately 0-100° C. to effect the removal of e.g. Mg, Fe, Al, etc., and the addition of a reagent to precipitate calcium, such as an oxalate salt (e.g. sodium oxalate, potassium oxalate, etc.) at temperatures in the range of approximately 0-100° C. Additionally, a sorbent or solvent exchange method of removing species (e.g. boron-containing species) may also be included.

The method may include pre-treating the solution to remove contaminants before contacting the solution with the metal-selective sorbent. Pre-treatment may remove sediments, foulants, hydrocarbons, and gases, and balance the pH of the solution. Those skilled in this art will understand that suitable pretreatment elements may include removal of sediment by filtration, flocculation to remove hydrocarbons, scrubbers to remove e.g. H₂S, and adjustment of brine pH by the addition of acids or caustics.

The method may also comprise purification of the solution. Purification may be achieved through the addition of a caustic (e.g., NaOH) to precipitate hydroxide salts of contaminants including Mg, Ni, Fe, Cu, etc. The addition of a reagent, such as sodium oxalate, may also be used to precipitate any remaining Ca in the solution. Purification may also be achieved through a carbonation reaction. The carbonation reaction converts metal chlorides to metal carbonates through a reaction with a bicarbonate salt, e.g., (NH₄)HCO₃, Na(HCO₃), etc. The metal carbonates are further purified through the application of pressurized CO₂ to effect redissolution of M(HCO₃) followed by controlled precipitation. Heat and vacuum may be applied to maximize precipitation of metal carbonates. Alternatively, purification may be achieved through electrolysis.

Purification of the solution results in the formation of a wet metal product. The wet metal may then be dried to obtain the desired dry metal product, for instance lithium carbonate. Throughout the method, there is the potential for dilution and/or concentration of the stream through the application of traditional means such as reverse osmosis, multi-effect distillation, etc.

One embodiment of the present invention is a modular system for concentrating and recovering at least one metal from a solution, the modular system comprising: a container further comprising a front wall, a rear wall, a first side wall, a second side wall, a bottom surface, a top surface, and an interior, wherein the interior comprises modules for concentrating and recovering the at least one metal; a fluid ingress port; a pre-conditioning module; and a metal extraction module comprising a metal-selective sorbent at least partially disposed within a bed column, wherein the metal-selective sorbent sorbs the at least one metal. The system may comprise additional modules, including a pre-conditioning module, a reverse osmosis module, a nanofiltration module, an electrodialysis module, a pre-treatment module, a polishing module, a carbonation module, a hydroxylation module, a product drying module, and a forward osmosis module. The modular system's ingress port may receive solution (for example, raw brine).

Preferably, each modular system is designed to be transportable to site location via conventional shipping methods such as truck and boat. As such, the individual modular system may be entirely disposed within standard-size shipping containers, e.g. in lengths of about 10 ft, 20 ft, and 40 ft variants. The front, rear, and side walls of the container may be about 8.5 ft high. The front and rear walls may have a width of about 8 ft and the side walls may have a length of about 20 ft. The modular system may be oriented in parallel or in series depending on solution composition and flow rates.

The set-up of the modular system is quick with minimal site preparation after arrival at the site. The modular system can be re-packed and transported to an alternative location based on changing requirements. The modular system requires basic utilities to be operational. Utilities may include gas and electricity provided by the local infrastructure. Alternatively, the modular system may be powered through self-sufficient means such as a gas or diesel generator. The modular system may also be powered by alternative energy systems, including wind, solar, hydroelectric, geothermal power, etc. External panels may be removable to easily access internal components. External tanks may be used to regulate in-rush flow, store chemicals, or store a final product or products. A plurality of modular systems may be connected and linked through detachable piping and data communication interfaces.

In another embodiment, the modular system comprises a pre-conditioning module. This module comprises an external tank to act as an in-rush buffer for the process as solution flow rates can vary. The solution is pumped through a type of microfiltration or ultrafiltration unit for sediment removal. Depending on brine source type, this pre-conditioning may also involve the removal of foulants, hydrocarbons, or gases through additional equipment. Hydrocarbons may be removed through flocculation. The solution may be heated, and pH may be modified by addition of acid or a base. Additionally, H2S or other gases may be removed through scrubbers. The resulting solution exits the unit and is passed into the extraction module.

In another embodiment, the modular system comprises a metal extraction module. Metal is extracted through a sorption process in the metal extraction module. The pre-conditioned solution passes through at least one sorption column where the solution contacts a metal-selective sorbent. The column or columns may be vertical and/or fixed bed. The concentration of metal in the solution decreases through subsequent processing until the metal is completely removed from solution. The columns may be oriented in such a way as to allow continuous adsorption and desorption without interruption in inlet flow. The sorption method may alternatively involve the use of batch sorption, continuous moving bed sorption, continuous fluidized bed sorption, and/or pulsed bed sorption or a combination thereof. The brine and recycling water may be heated to temperatures between approximately 0° C. and 100° C. before entering the sorbent column. The system operates with residence times between approximately 0.1 and 100 hours, pH levels between approximately 2 and 10, and inlet pressures between approximately 1 and 18 atmospheres. The metal depleted brine is transferred to an external waste tank for water recycling via the reverse osmosis module.

In another embodiment, the modular system comprises a reverse osmosis module. To lower water consumption of the overall process, the waste brine from the metal extraction module is transported to the reverse osmosis module for water recovery. High pressure pumps and reverse osmosis membranes are used to further concentrate the waste stream while recovering water for potential use for other users, the carbonation module, or the metal extraction module. A two-stage system is used to obtain high water recovery. Operation inlet pressures range from approximately 7 to 100 atm. An external water tank is used to account for differences in supply and demand of the recycled water.

In another embodiment, the modular system comprises a nanofiltration module. The metal eluate from the metal extraction module may be sent to the nanofiltration module for the removal of divalent ions and metal compounds. The nanofiltration module comprises a metal-selective membrane comprising a metal organic framework (MOF) and/or charged polymeric membranes. These membranes may be in flat sheet, spiral wound, or hollow tube orientations. The metal-selective membrane may operate at a temperature within the range of approximately 0° C. to 100° C. and pressures ranging from approximately 1 atm to 100 atm. The metal-selective membranes may be orientated in parallel and series to ensure adequate waste rejection, metal recovery, and adequate performance at varying flow rates. The solution produced from the nanofiltration module is then transferred to the pre-treatment module.

In another embodiment, the modular system comprises an electrodialysis module. The electrodialysis module may comprise an electrodialysis cell and electronic equipment required to control the voltage of the cell. The metal eluate from the metal extraction module is sent to the electrodialysis module. The electrodialysis module produces two waste streams through the application of electricity to the electrodialysis cell. The first stream is a metal chloride-rich stream that is then sent to the polishing module. The second stream is a waste stream that is then sent to the reverse osmosis module for water recovery. The solution produced from the electrodialysis module is then transferred to the pre-treatment module.

In another embodiment, the modular system comprises a forward osmosis module. The forward osmosis module receives input brine from the metal extraction module. The solution contacts the feed side of the forward osmosis membrane, while a draw solution is pumped on the opposite side of the membrane. The solution, including at least one metal, is transported across the semi-permeable membrane using osmotic pressure as the driving force. A draw solution provides the osmotic pressure difference to generate enough force to transport at least one metal across the forward osmosis membrane. The forward osmosis membrane may operate co-currently, or counter-currently and may comprise two inlet and outlet streams, the draw solution, and the solution. The draw solution may compromise a bicarbonate salt. The bicarbonate salt may include e.g. ammonium bicarbonate, ammonium carbonate, sodium bicarbonate, potassium bicarbonate and/or any combination of these bicarbonate salts. The draw solution provides enough osmotic pressure solution to transfer enough metal for a reaction to occur. The transferred metal may be metal ions or a metal chloride. Taking LiCl as an example, the LiCl in the solution reacts with a carbonate draw solution according to the following reaction(s):

2NH₄HCO₃+2LiCl→Li₂CO₃+2NH₄Cl+CO₂+H₂O Eqn. 1

2Li(HCO₃)≈Li₂CO₃+CO₂ Eqn. 2

Metal chlorides that permeate the forward osmosis membrane react in situ with the bicarbonate salt draw solution to form a metal carbonate. The lithium carbonate solution moves from the forward osmosis membrane to a reaction vessel(s) to increase the yield of the carbonation reaction. The solution is then transferred to a set of selective separation units to selectively precipitate the lithium carbonate as a solid slurry for further drying and purification. The separator operates at temperatures greater than approximately 35° C. and therefore the unreacted bicarbonate decomposes to form e.g. gaseous ammonia, carbon dioxide and water which are recycled to an earlier stage. The remaining ammonium chloride rich solution carries on to the final reactor where it proceeds with the following reaction:

2NH₄Cl+CaO→2NH₃+CaCl₂+H₂O Eqn. 3

Following the reactor, the solution proceeds to a final separation system where the calcium chloride is separated from ammonia and water. Ammonia and water are recycled to the first reactor(s) and the process continues. The lithium carbonate product that is separated from this module is then transferred to the product drying module.

Forward osmosis membranes may range in number from approximately 1 to 10, and may be oriented in parallel or in series. In addition, anti-fouling methods, including backflushing, polarity reversal, electromagnets, and/or anti-scalants, may be used to reduce fouling in the forward osmosis membrane. The forward osmosis membranes may be either commercial or proprietary membrane. The forward osmosis membranes may be a flat sheet, spiral wound, or hollow tube orientations. The solution produced from forward osmosis module is then transferred to the pre-treatment module.

In another embodiment, the modular system may comprise a pre-treatment module. The pre-treatment module takes a polished metal solution from the nanofiltration, electrodialysis, or forward osmosis modules and adjusts the pH of solution pH by acid or base addition. This module may also remove select waste contaminants through the addition of a coagulant. The solution may be sent through a static mixer before being transferred to the polishing module. External base, acid, and coagulant storage tanks may also be in communication with the pre-treatment module.

In another embodiment, the modular system may comprise a polishing module. The polishing module removes any undesirable components that remain after the solution exits the pre-treatment module. The polishing module contains acid and base storage tanks that enable the increase of the pH to values suitable for the generation and precipitation of e.g. Mg, Fe, Al, and similar metals, as well as hydroxides. The polishing module operates at temperatures in the range of approximately 0-100° C. The polishing module comprises a static mixer and a clarifier to enable the precipitation and subsequent separation of contaminants. This module can also house a sorbent system for removal of boron-containing species depending on the solution components. Any waste slurry solution is sent to be recycled and the solution continues to the carbonation module or hydroxylation module.

In another embodiment, the modular system comprises a carbonation module. The carbonation module receives the product stream from the polishing module. This module contains a bicarbonate salt storage tank. The solution is mixed with the appropriate amount of bicarbonate salt to produce the metal carbonate product (e.g. lithium carbonate) in a static mixer. The metal carbonate product is separated from the reaction mixture in a clarifier. After collection, the carbonate salt can be further purified by redissolution in water followed by the addition of pressurized CO₂ in a pressure reactor. Controlled reduction of the pressure results in precipitation of the metal carbonate product, which is collected through filtration in a horizontal bed filter or filter bag.

In another embodiment, the modular system comprises a hydroxylation module. The hydroxylation module receives solution from the polishing module. This module comprises an electrolytic cell. The solution is transferred to the cell in which the appropriate voltage is applied to effect the electrolysis of water. The resultant metal hydroxide product is collected via filtration using a horizontal bed filter or filter bag before transfer to the product drying module.

In another embodiment, the modular system comprises a product drying module. The product drying module receives the solid wet metal product. The wet metal product is completely dried in preparation for packaging using a tray dryer, vent dryer, drum dryer, or fluidized bed dryer.

The overall process can be oriented in any of the following ways:
1. Preconditioning Module-Metal Extraction Module-Nanofiltration Module
2. Preconditioning Module-Metal Extraction Module-Nanofiltration Module-Pre-treatment Module, Polishing Module, Carbonation Module-Product Drying Module
3. Preconditioning Module-Metal Extraction Module-Electrodialysis Module-Pre-treatment Module-Polishing Module-Carbonation Module-Product Drying Module
4. Preconditioning Module-Metal Extraction Module-Forward Osmosis Module-Product Drying Module
5. Preconditioning Module-Metal Extraction Module-Nanofiltration Module-Pre-treatment Module-Polishing Module-Hydroxylation Module-Product Drying Module
6. Preconditioning Module-Metal Extraction Module-Electrodialysis Module-Pre-treatment Module-Polishing Module-Hydroxylation Module-Product Drying Module

Another embodiment of the present invention is an apparatus for recovering at least one metal from a solution, comprising a metal-selective membrane. The metal-selective membrane may be a nanoporous membrane. The metal-selective membrane may isolate and/or concentrate metal or compounds, such as Li and/or LiCl. Additionally, the metal-selective membrane may comprise a zeolitic imidazolate framework, or other suitable metal organic frameworks (MOFs) such as UiO-66, on an anodic aluminum oxide substrate, carbon-based substrate, or other suitable substrate. The selective membrane may comprise graphene, graphene oxide, uniform sub-nanometer dehydrating pores, ion-conductive pores, embedded metal ions, or other suitable materials. The metal-selective membrane may have a lamellar orientation with the substrate on the bottom and one or multiple layers of deposited metal organic framework (e.g., UiO-66 or ZIF-8). The MOF layer may also be protected with a water and metal permeable layer of polymer. Alternatively, the MOF may be deposited onto or within a tubular alumina membrane with a potential polymeric protective layer. Alternately, the MOF particles may be synthesized separately and then embedded in a polymer layer by suspending the particles in the polymer solution prior to solution-casting of the membrane. An electric field may also be applied to the metal-selective membrane.

The metal-selective membrane may have sub-nanometer dehydrating pores with diameters in the range of about 3.4 to less than 4.67 Angstroms, about 3.4 to about 4.6 Angstroms, about 3.4 to about 4.4 Angstroms, about 3.4 to about 4.2 Angstroms, about 3.4 to about 4.0 Angstroms, about 3.4 to about 3.8 Angstroms, or about 3.4 to about 3.6 Angstroms. The metal-selective membrane may have ion-conductive pores with diameters in the range of about 3.4 to less than 4.67 Angstroms, about 3.4 to about 4.6 Angstroms, about 3.4 to about 4.4 Angstroms, about 3.4 to about 4.2 Angstroms, about 3.4 to about 4.0 Angstroms, about 3.4 to about 3.8 Angstroms, or about 3.4 to about 3.6 Angstroms. The metal-selective membrane may have a surface area of 1612.7 m²/g, a pore diameter selected from a range of 3.5 Å to 4.6 Å, and a pore volume of 0.61 m³/g.

It is known that the hydrated atomic radii of lithium ions are 3.4 Angstroms (1 Å=0.1 nm) and that the hydrated atomic radii of Mg ions are 4.67 Å. This difference in radius is related to Li's monovalent and Mg's multivalent ion character. The charge of a hydrated Li ion is 0.29 with a conductivity of 1.1×107 S/m, while the charge of a hydrated Mg ion is 0.43 with a conductivity of 2.3×107 S/m. Those skilled in the art will understand, based on quantum effects in electric transport, that ions undergo a dehydration process to enter a uniform subnanometer pore, and that windows act as ion selectivity filters, while cavities act as ion-conductive pores. Those skilled in this art will understand that synthesis of a nanoporous membrane specific for engagement with and sequestering therein of Li ions and/or LiCl will provide creation of cavities and nanopores therein that are specific to the hydrated atomic radii of lithium ions, i.e., having pore sizes and/or cavities that are equal to or greater than 3.4 Å but less than 4.67 Å, for example between the range of 3.4 Å to 4.6 Å, 3.45 Å to 4.55 Å, 3.5 Å to 4.6 Å, 3.55 Å to 4.45 Å, 3.6 Å to 4.4 Å, 3.65 Å to 4.35 Å, 3.7 Å to 4.3 Å, 3.75 Å to 4.25 Å, and anywhere between.

Another embodiment of the present invention comprises a column jacket apparatus for heating a solution entering a column. The column jacket apparatus heats the reactor and the inlet solutions in a single fluid-containing jacket before the solutions are sent through the main extraction column for metal recovery. This column jacket apparatus comprises of smaller internal cylinder holding column that is packed with sorbent media while the larger outer cylinder encases the heated jacket fluid. The inlet fluids are spiraled inside a solution conveyor between the inner and outer cylinders to interact and come to equilibrium temperature with the heated jacketed liquid. Once the solution has been heated, it is sent downwards through a vertical packed column for the target metal to be absorbed. Upon desorption, the stripping solution follows the same path. These inner and outer cylinders may comprise materials such as glass, plastic, metal, or a combination thereof where the top and bottom caps are secured through press-fit or attached with bolts for higher pressure scenarios. The unit may have a diameter to length ratio of approximately 1:1 and up to approximately 1:100 based on the type of sorbent used, inlet flow rate, and the specific target metal(s) to be extracted. The unit can be disassembled to allow for re-packing of sorbent medium when needed. The jacket fluid may be water, oil, or a coolant with sorption operating temperatures ranging from approximately 5° C. to approximately 100° C. and pressures from approximately 1 to approximately 18 atm. As desired, the jacketed fluid may also run co-current or counter-current by reversing the fluid flow direction. These operating parameters are dependent on sorbent media type, sorbent particle size, inlet flow rate, and target metal to be extracted.

The addition of three-way valves and energy-recovering heat exchangers may further optimize extraction performance in this apparatus. It may be desirable to strip the sorbent from bottom up (counter-current to metal containing brine) which requires the reversal of flow during the desorption step. Heat exchangers may also recover energy from the hot metal-depleted and eluate solutions for recycling back to the fluid-containing jacket. This system may be used in continuous adsorption systems through the addition of a second column. In this configuration, the inlet flow is not interrupted through adsorption and desorption steps and is viable for larger scale extraction processes.

Another embodiment of the present invention is a method for synthesizing a metal-selective membrane. The method for synthesizing metal-selective membrane comprises mixing a metal precursor salt, organic linker unit, solvent, and optionally an activator. There are multiple methods of producing the metal-selective membrane apparatus. Production of the metal-selective membrane itself requires small particles of the metal organic framework (MOF). Depending on the metal, the particles may be synthesized by dissolving each component (i.e., metal precursor and linker) in solvent (e.g., deionized water) and then adding the metal solution to the linker solution with agitation, such as stirring. The solutions are then mixed for at least approximately 15 minutes to produce membrane solution and the precipitate product is separated from solution via centrifugation or filtration. The resultant slurry is left to dry either at room temperature or in an oven (at approximately 60° C.). The linker to metal ratio can vary significantly from about 1:1 to about 1:100. The resultant MOF particles may be mixed into a polymer blend and the resultant mixture is then spread thinly and allowed to polymerize to produce a membrane, which can range in thickness from approximately 20 μm to approximately 300 μm.

The MOF particles may be seeded onto a substrate, such as anodic aluminum oxide (AAO), graphene, carbon paper or tubular alumina membrane, in preparation for the synthesis of the layer of MOF on the substrate. To seed the membrane, a paste of the particles is produced (in deionized water or other suitable solvent). The paste is then applied to the membrane substrate and allowed to dry. The MOF may be coated onto a substrate that has either been seeded with MOF particles or not seeded with MOF particles. The holes on the ends of the membrane can be plugged (e.g., with a stopper) to prevent access of the MOF to the interior of the tube if the substrate is a tubular alumina membrane. To coat the membrane, the following procedures can be used:

(1) The substrate is oriented in a container such that it is resting on its edges with the flat portions of the membrane suspended. A mixture of the appropriate metal (e.g., Zn(NO₃)₂.H₂O) and linker (e.g., 2-methylimidazole) in a suitable solvent (e.g., deionized water) is added to the beaker. This mixture may be produced by dissolving each individual component in DI water and then mixing the two together or by dissolving both components in DI water at the same time. The membrane solution is left in contact with the substrate e.g. for approximately 24 hours but can be left indefinitely. The resultant membrane apparatus is then washed with a solvent (e.g., ethanol) and stored in DI water.

(2) The substrate is oriented in a holder such that one side of the substrate is in contact with a metal precursor solution and the other side is in contact with a linker solution in a suitable solvent (e.g., DI water or ethanol). The holder can be two glass frit funnels held together with the substrate in the middle and an O-ring surrounding the substrate to contain the liquid or any apparatus that enables each solution to be in contact with the opposite sides of the membrane. The reaction can be continued for approximately 1 hour to approximately 48 hours. After the reaction, the membrane is removed, rinsed with a suitable solvent (e.g., ethanol), and left to dry or stored in solution.

(3) The substrate is placed in a container such as a beaker, petri dish, or crystallization dish. An O-ring is placed around the membrane and a funnel is carefully placed on top of the O-ring. The membrane solution of metal precursor, linker, and a potential activator in a suitable solvent (e.g., water, ethanol, or DMSO) is placed into the top of the funnel and the reaction is left to react for approximately 1-24 hours.

(4) The substrate may be placed in a container (beaker, petri dish, Teflon liner, etc.). A solution of the metal precursor (e.g., ZrCl₄) and an optional activator (e.g., terephthalic acid) in dimethyl formamide is produced and stirred until a clear solution is obtained (either under an inert atmosphere or air). The membrane solution is added to the substrate in the container, covered with a lid (e.g. watch glass or Teflon liner lid), and placed in a vacuum oven for at least e.g. 2 days at approximately 120° C. The container is then removed from the oven and left for e.g. 1 hour. The membrane is removed, rinsed with solvent (e.g. ethanol) multiple times and then soaked in a solvent (e.g., ethanol) for e.g. approximately 12 hours. The membrane is then activated in the oven for e.g. approximately 1 hour at 100° C.

Another embodiment of the present invention relates to a loop apparatus for recovering at least one metal from a solution. The apparatus comprises a series of two or more loop-shaped apparatus, wherein each loop-shaped apparatus comprises a water-permeable membrane and a metal-selective membrane. Water molecules pass through the water-permeable membrane in the descending limb of the apparatus loop while metal and water molecules pass through the metal-selective membrane in the ascending limb of the apparatus loop. The flow occurs in pulses under the influence of pressure changes that are initiated by the flow of the dewatered or diluted solution under the control of a valve and a pump. The osmolarity of the filtered solution in the conical collection basin will gradually concentrate to create an increasing gradient towards the bottom of the receiving metal concentration apparatus. The concentration gradient causes a cascade flow of the metal-containing solution from the first loop-shaped apparatus to the next loop-shaped apparatus. Water molecules from the filtered solution received from the first loop-shaped apparatus pass through the water-permeable membrane in the descending limb of the second loop-shaped apparatus loop. Metal particles pass through the metal-selective membrane in the ascending limb of the second loop-shaped apparatus, thereby further enriching the metal concentration in the solution. One embodiment incorporates two or more of the loop apparatuses to form a cascade system for enrichment of recovered metal from a solution. Enrichment is accomplished by sequential flow of dewatered or diluted solution through a plurality of loop apparatuses.

Another embodiment of the present invention comprises a system for recovering a metal carbonate from a solution by forward osmosis. This system comprises solution that enters the forward osmosis membrane at temperatures ranging from approximately 0° C. to 35° C., pressures ranging from approximately 10 to 2,000 kPag and concentrations ranging from approximately 20,000 to 100,000 ppm. A draw solution enters the forward osmosis membrane(s) at temperatures ranging from approximately 0° C. to 50° C., pressures ranging from approximately 10 to 2,000 kPag and concentrations of carbonates in solution less than approximately 6 mol/L. The greater the difference in concentrations between the solution and the draw solution, the greater the osmotic pressure will be to pull the feed solution through the membrane. Compositions and operating conditions surrounding outlet streams will be determined once the flux value is been established and energy balances have been performed. The solution transports itself across the semi-permeable membrane using osmotic pressure as the driving force. The forward osmosis membrane device may operate co-currently, or counter-currently and may comprise two inlet and outlet streams: the draw solution, and the solution. The draw solution may compromise a bicarbonate salt; this could include ammonium bicarbonate, ammonium carbonate, sodium bicarbonate, potassium bicarbonate and/or any combination of these bicarbonate salts. The carbonate draw solution provides enough osmotic pressure for the solution to transfer enough metal for a reaction to occur. The transferred metal chloride, for example LiCl, reacts with the carbonate draw solution according to the following reaction(s):

2LiCl+(NH₄)₂CO₃→Li₂CO3+2NH₄Cl Eqn. 4

2NH₄HCO₃+2LiCl→Li₂CO₃+2NH₄Cl+H₂O+CO₂+H₂O Eqn. 1

The reaction(s) presented may differ slightly based on the draw solution used and contaminants present, and other carbonate products, such as MgCO₃ and/or CaCO₃ may be produced via analogous reactions. However, the metal carbonate product will remain the same. The metal carbonate solution will then move from the forward osmosis membrane to reaction vessel(s) enabling the reaction to proceed to achieve a conversion of metal chloride e.g. approximately 80% to approximately 100%.

The purpose of the first reactor is to carry out the carbonation reaction to complete conversion. For example, the reaction of ammonium bicarbonate with the lithium chloride solution takes time to proceed and therefore is placed in a liquid-liquid reaction vessel for sufficient time based on kinetic data. The reaction is completely liquid phase; therefore, a continuous stirred tank reactor (or multiple in series) or a reactor of similar design may be used. Temperature may be less than approximately 35° C. in the reactor vessel to avoid the decomposition of e.g. ammonium bicarbonate and may be done under slight vacuum (e.g. approximately 760 to 25 Torr) to promote the reaction. An exhaust fan might be used to capture the carbon dioxide off-gas which will be recycled to a fourth reactor. Optimal reactions, using Li as an example, for the first reactor are listed below (same as listed in forward osmosis membrane but to completion):

2LiCl+(NH₄)₂CO₃→Li₂CO₃+2NH₄Cl Eqn. 4

2NH₄HCO₃+2LiCl→Li₂CO₃+2NH₄Cl+CO₂+H₂O Eqn. 1

The first separator unit in this system is be heated to temperatures e.g. greater than 35° C. to allow excess ammonium bicarbonate to decompose according to the following reaction:

NH₄HCO₃→NH₃+CO₂+H₂O Eqn. 6

The three products (ammonia, carbon dioxide, and water) are recycled to their respective reactors (a third reactor and the fourth reactor). Metal bicarbonates may have a negative temperature coefficient of solubility and increasing the temperature above approximately 35° C. may result in the precipitation of additional metal carbonates as its solubility limit is exceeded according to the following equation:

2NH₄HCO₃+2LiCl→Li₂CO₃+2NH₄Cl+CO₂+H₂O Eqn. 1

The products will be separated using selective precipitation/crystallization in a solid-liquid separation unit. The first reactor and the separation unit(s) may also be combined into one heated crystallization unit where the reaction would occur. Metal carbonate slurry is removed from the separation unit(s) and sent to a drying and purification stage.

The ammonium chloride by-product from reaction (2) above may be further processed using a reaction in a second reactor with the calcium oxide produced from calcination. The aqueous ammonium chloride solution reacts with calcium oxide according to the following reaction:

2NH₄Cl+CaO→2NH₃+CaCl₂+H₂O Eqn. 3

The product stream is sent to separation unit(s) for further processing.

The ammonium-calcium chloride-water product stream from the second reactor is separated using solid-liquid-vapor separation by a plurality of separator units. Ammonia and water vapor may be captures by increasing the temperature. Depending on the concentration of contaminants in the solution, the solution can either be evaporated to a slurry to remove any contaminants or evaporated to the solubility limit of calcium chloride. In the former case, the water will be recaptured and used as a pure water inlet in the system. In the latter case, the water will be separated from the calcium chloride through filtration or settling and decanting and returned to the process. Any recaptured ammonia will also be returned to the draw stream.

The purpose of the third reactor is to create ammonia water used in the fourth reactor to create ammonium bicarbonate (or ammonium carbonate). Liquid gas reaction of ammonia (NH₃) and water occurs inside the third reactor to produce ammonia water according to the following reaction:

NH₃+H₂O←→NH₄⁺+OH⁻ Eqn. 7

The fourth reactor is very similar in design to the third reactor. A liquid-gas reaction of ammonia water and carbon dioxide occurs in the third reactor. Depending on inlet concentration ratios, ammonium carbonate or ammonium bicarbonate may be produced. Ammonia water from the third reactor and carbon dioxide from the calcination reactor will flow into fourth reactor. The carbonation reaction proceeds according to the following reaction(s):

CO₂+H₂O←→H⁺+HCO₃⁻ Eqn. 8

HCO₃⁻←→H⁺+CO₃²⁻ Eqn. 9

NH₃+HCO₃⁻←→NH₂COO⁻+H₂O Eqn. 10

NH₄⁺+HCO₃⁻←→NH₄HCO₃ Eqn. 11

The calcination reactor is used as an alternative to ammonium bicarbonate as a raw material. Calcium carbonate (limestone) is fed as a solid raw material to the calcination reactor. The calcination reactor may comprise a rotary kiln. The reactor operates at temperatures of 900-1100° C. and allows enough time for complete thermal decomposition of calcium carbonate (limestone) according to the following reaction:

CaCO₃→CO₂+CaO Eqn. 12

The carbon dioxide gas is captured using an exhaust fan, optionally pressurized, and fed to fourth reactor for the carbonation of ammonia water. Calcium oxide (CaO) is transported to the second reactor.

In the case that the forward osmosis membrane is not solely metal chloride selective, the draw solution will contain contaminant ions such as Na, K, Mg, Ca, etc. To ensure that there is not a buildup of these contaminants over time, a percentage of the solution may be removed from the system during each cycle and replaced with fresh water. This percentage may range from 0-100% depending on the contaminant concentrations. Depending on the metal content of the waste stream, it would either be returned to the beginning of the metal-selective sorbent stage of the overall process described or be returned to a water recovery module (e.g., reverse osmosis, electrodeionization, or crystallizer) to recover the fresh water for return to the circuit. Alternatively, the solution may be directly disposed of.

During the process, it is important that the draw solution, comprising an aqueous solution of bicarbonate salt, maintain a consistent concentration, i.e., near saturation. The draw solution concentration is maintained at saturation through the combined effects of the third and fourth reactors and the calcination reactor. Alternatively, the concentration may be maintained at saturation through the flow of the draw solution through a column or chemical dispenser containing the bicarbonate salt. The draw solution may be in contact with the bicarbonate salt for sufficient/excess time to ensure that the solution reached saturation. This column or chemical dispenser could either replace the recycle circuit described by fourth and third reactors and the calcination reactor or be added between the fourth reactor and the forward osmosis membrane to ensure that the draw solution was at saturation before contacting the forward osmosis membrane.

### DETAILED DESCRIPTION OF THE DRAWINGS

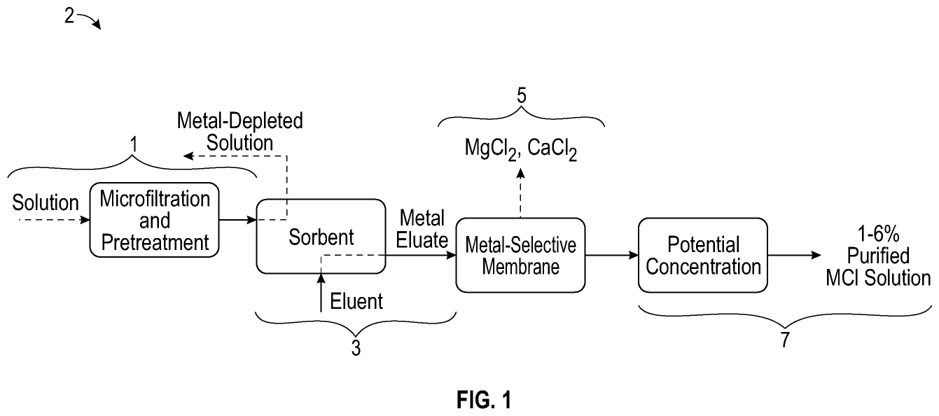

Method 2 depicted in FIG. 1 uses metal-selective membrane and concentration processing steps to recover at least one metal from a solution. A solution, for example brine, is pretreated 1. The solution is then contacted with a metal-selective sorbent in a column and an eluent is washed over the metal-sorbent complex to elute a metal eluate, with metal-depleted solution removed from system 3. The metal eluate is subsequently contacted with a metal-selective membrane and chloride contaminants 5 are removed to form a polished metal solution. The polished metal solution is concentrated to form approximately a 1-6% concentrated metal solution 7.

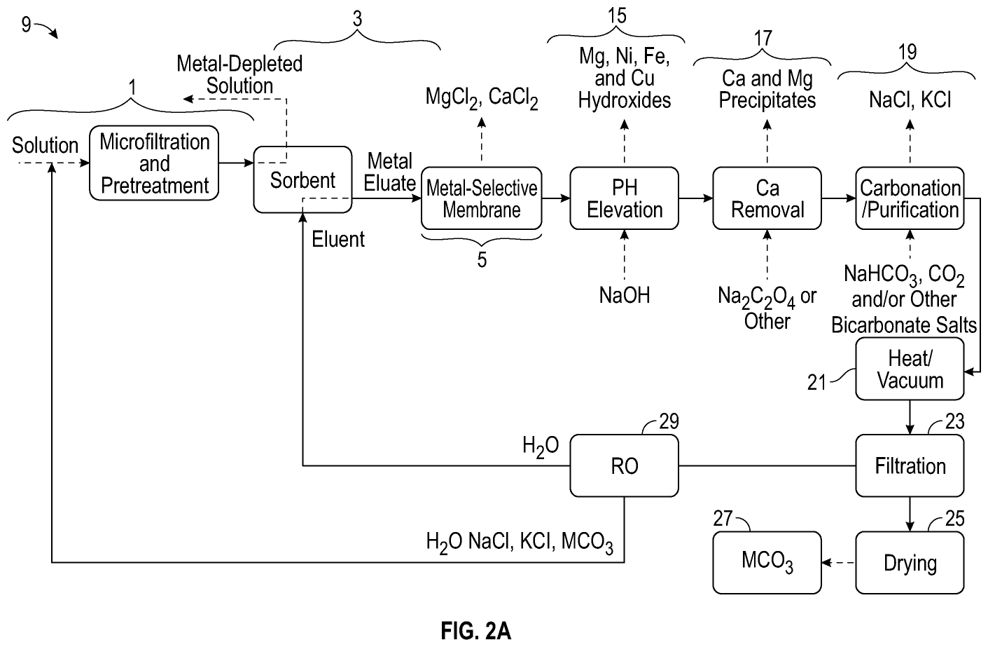

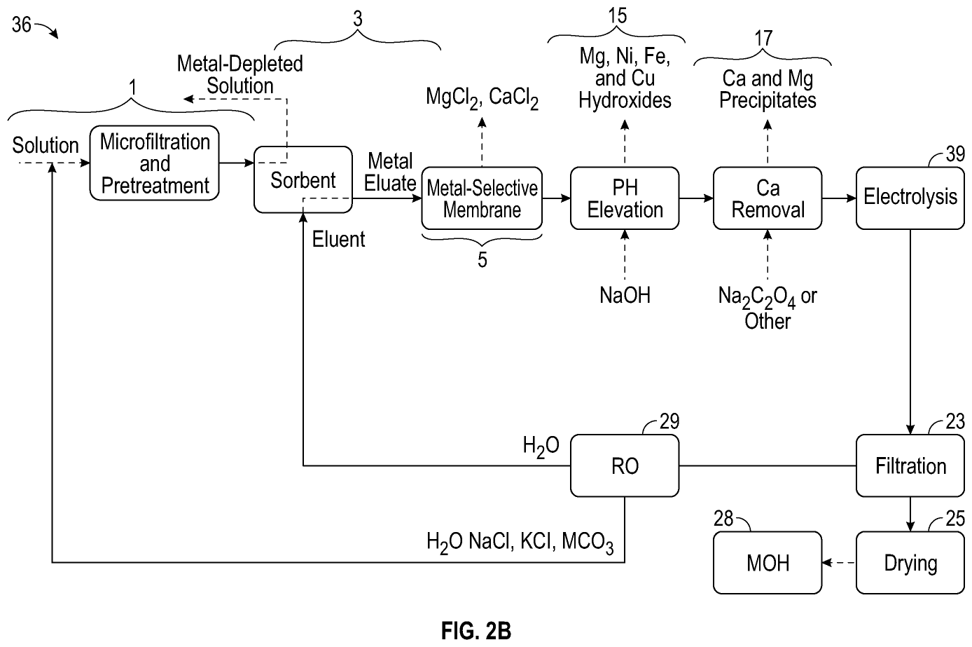

Method 9 depicted in FIG. 2A uses metal-selective membrane and purification processing steps to recover at least one metal from a solution. A solution, for example brine, is pre-treated and filtered 1. The solution is then contacted with a metal-selective sorbent in a column and an eluent is washed over the metal-sorbent complex to elute a metal eluate, with metal-depleted solution removed from system 3. The metal eluate is subsequently contacted with a metal-selective membrane and chloride contaminants are removed 5 to form a polished metal solution. The polished metal solution is then purified by pH elevated 15, Ca removal 17, carbonation 19, and application of heat and vacuum 21 to form a purified solution. pH elevation 15, Ca removal 17, and carbonation 19, result in the in removal of unwanted metals and hydroxides, Ca and Mg, and unwanted metal salts. The purified solution is then filtered 23 to form a wet metal product and filtrate. The filtrate is recovered and separated by separator 29. Water is returned as eluent to the sorbent and column 3 and water, NaCl, other salts, and metal carbonate compounds are returned to the solution to undergo pretreatment 1. The wet metal product is dried 25 and the dry metal carbonate product 27 is recovered.

Method 36 depicted in FIG. 2B uses metal-selective membrane and purification processing steps to recover at least one metal from a solution. A solution, for example brine, is pre-treated and filtered 1. The solution is then contacted with a metal-selective sorbent in a column and an eluent is washed over the metal-sorbent complex to elute a metal eluate, with metal-depleted solution removed from system 3. The metal eluate is subsequently contacted with a metal-selective membrane and chloride contaminants are removed 5 to form a polished metal solution. The polished metal solution is then purified by pH elevated 15, Ca removal 17, and electrolysis 39, and application of heat and vacuum 21 to form a purified solution. pH elevation 15 and, Ca removal 17, and carbonation 19, result in the removal of unwanted metals and hydroxides, Ca and Mg, and unwanted metal salts. The purified solution is then filtered 23 to form a wet metal product and filtrate. The filtrate is recovered and separated by separator 29. Water is returned as eluent to the sorbent and column 3 and water, NaCl, other salts, and metal carbonate compounds are returned to the solution to undergo pretreatment 1. The wet metal product is dried 25 and the dry metal hydroxide product 28 is recovered.

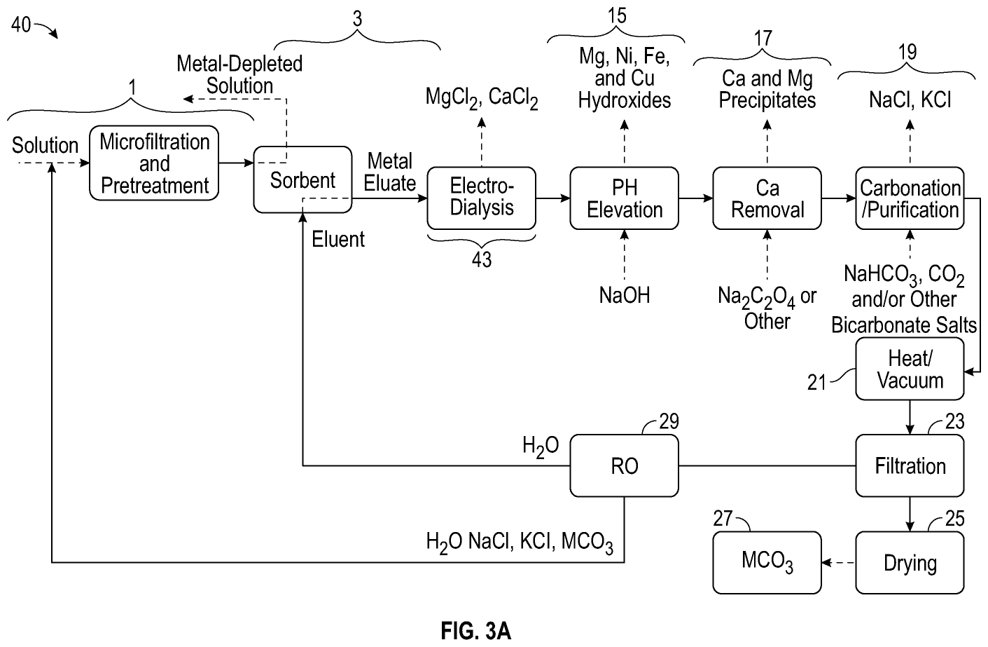

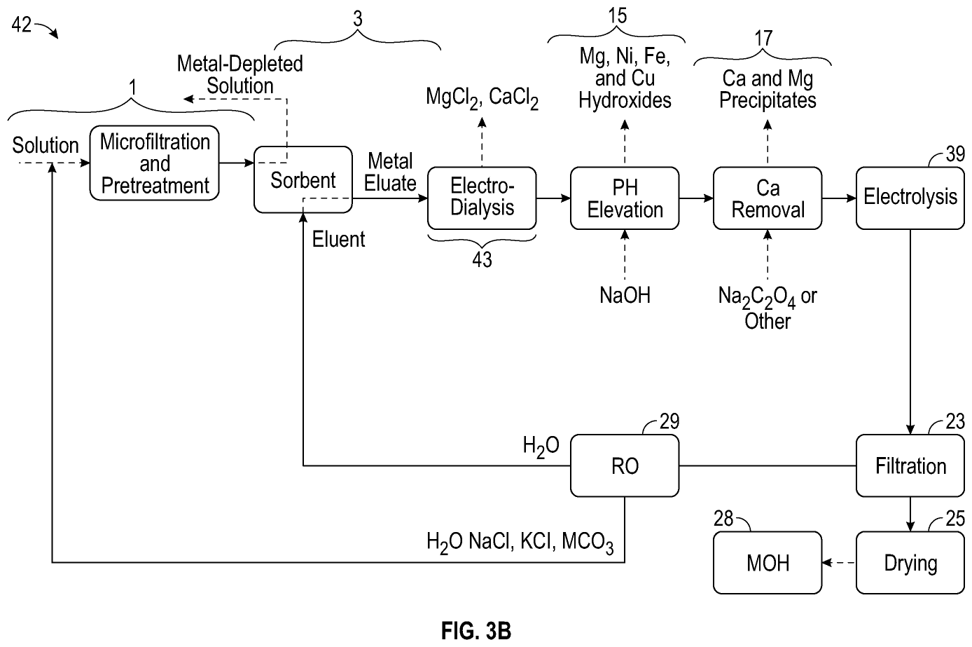

Method 40 depicted in FIG. 3A uses electrodialysis and purification processing steps to recover at least one metal from a solution. A solution, for example brine, is pre-treated and filtered 1. The solution is then contacted with a metal-selective sorbent in a column and an eluent is washed over the metal-sorbent complex to elute a metal eluate, with metal-depleted solution removed from system 3. The metal eluate subsequently undergoes electrodialysis and chloride contaminants are removed 43 to form a polished metal solution. The polished metal solution is then purified by pH elevated 15, Ca removal 17, carbonation 19, and application of heat and vacuum 21 to form a purified solution. pH elevation 15, Ca removal 17, and carbonation 19, result in the in removal of unwanted metals and hydroxides, Ca and Mg, and unwanted metal salts. The purified solution is then filtered 23 to form a wet metal product and filtrate. The filtrate is recovered and separated by separator 29. Water is returned as eluent to the sorbent and column 3 and water, NaCl, other salts, and metal carbonate compounds are returned to the solution to undergo pretreatment 1. The wet metal product is dried 25 and the dry metal carbonate product 27 is recovered.

Method 42 depicted in FIG. 2B uses electrodialysis and purification processing steps to recover at least one metal from a solution. A solution, for example brine, is pre-treated and filtered 1. The solution is then contacted with a metal-selective sorbent in a column and an eluent is washed over the metal-sorbent complex to elute a metal eluate, with metal-depleted solution removed from system 3. The metal eluate subsequently undergoes electrodialysis and chloride contaminants are removed 43 to form a polished metal solution. The polished metal solution is then purified by pH elevated 15, Ca removal 17, electrolysis 39, and application of heat and vacuum 21 to form a purified solution. pH elevation 15, Ca removal 17, and carbonation 19, result in the in removal of unwanted metals and hydroxides, Ca and Mg, and unwanted metal salts. The purified solution is then filtered 23 to form a wet metal product and filtrate. The filtrate is recovered and separated by separator 29. Water is returned as eluent to the sorbent and column 3 and water, NaCl, other salts, and metal carbonate compounds are returned to the solution to undergo pretreatment 1. The wet metal product is dried 25 and the dry metal hydroxide product 28 is recovered.

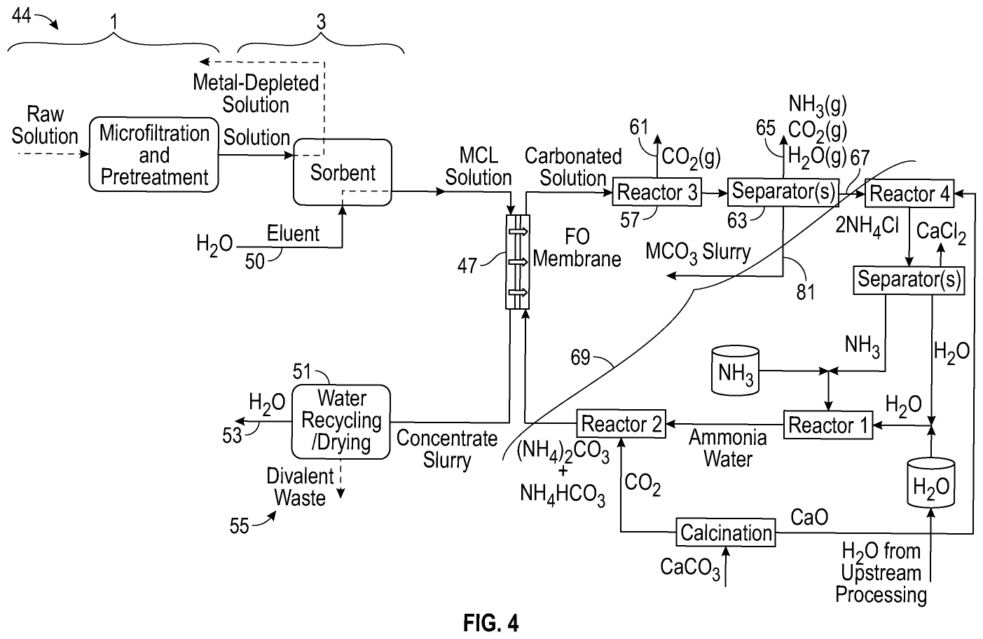

Method 44 depicted in FIG. 4 uses forward osmosis membrane processing steps to recover metals from a solution. A solution, for example brine, is pre-treated and filtered 1. The solution is then contacted with a metal-selective sorbent in a column and an eluent is washed over the metal-sorbent complex to elute a metal eluate, with metal-depleted solution removed from system 3. Eluent is introduced to the metal-selective sorbent and column through external source 50. The metal eluate contacts forward osmosis membrane 47 at least partially disposed around draw solution and proceeds to reactor 57. CO2 61 is released as waste from reactor 57. Reactor 57 facilitates a chemical conversion and the metal eluate, is transferred to at least one separator 63. The separator removes contaminants 65 and generates wet metal product 81. The waste from at least one separator 63 is transferred to recycling system 69 that reincorporates usable materials into forward osmosis membrane 47. Waste from forward osmosis membrane 47 is transferred for water recycling and drying 51 and water 53 and divalent waste 55 are expelled.

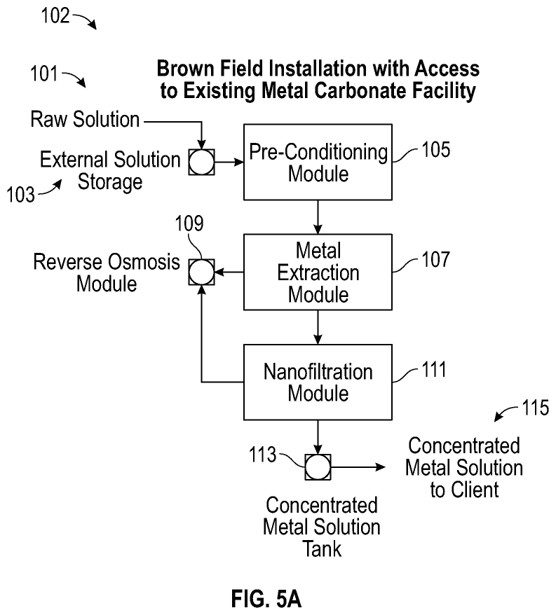

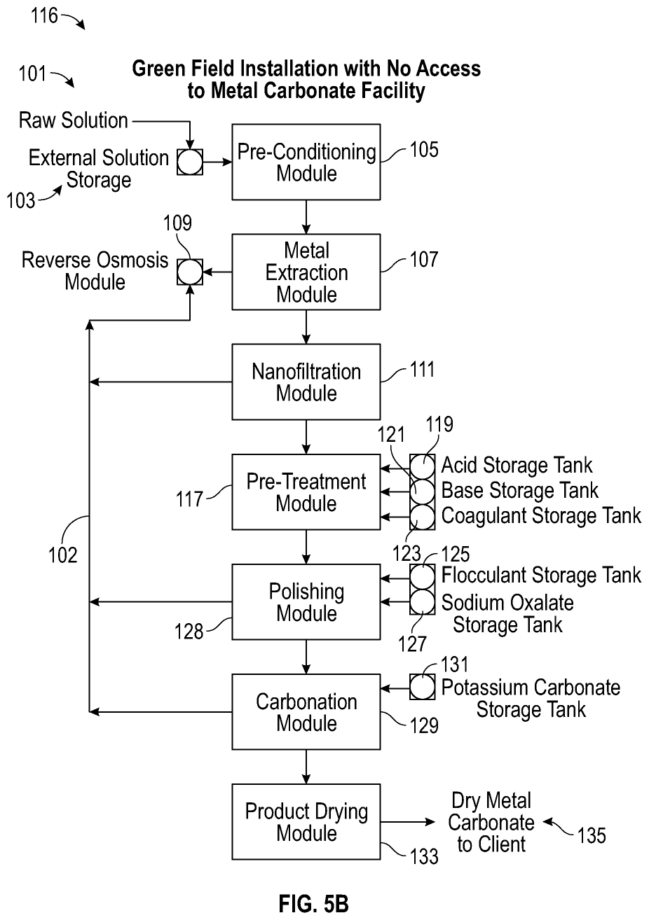

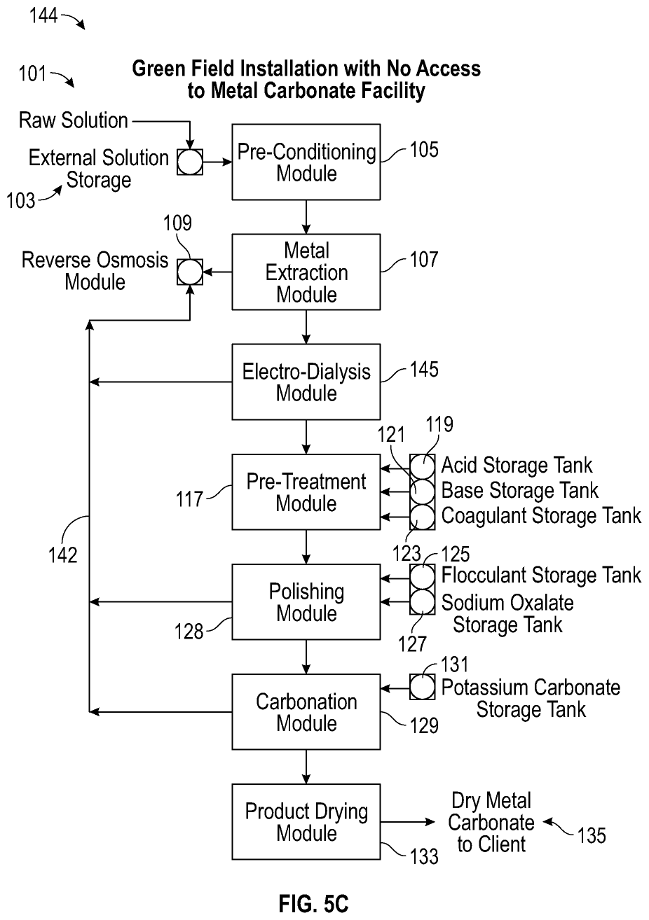

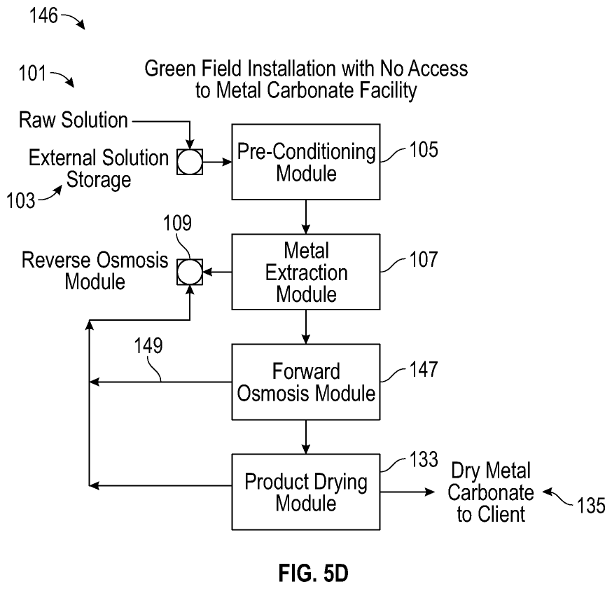

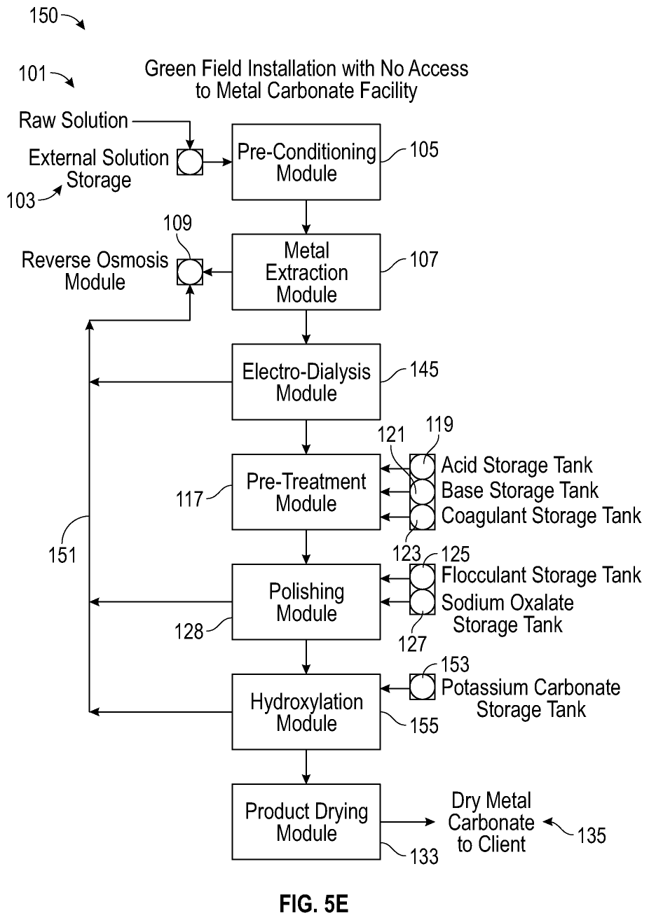

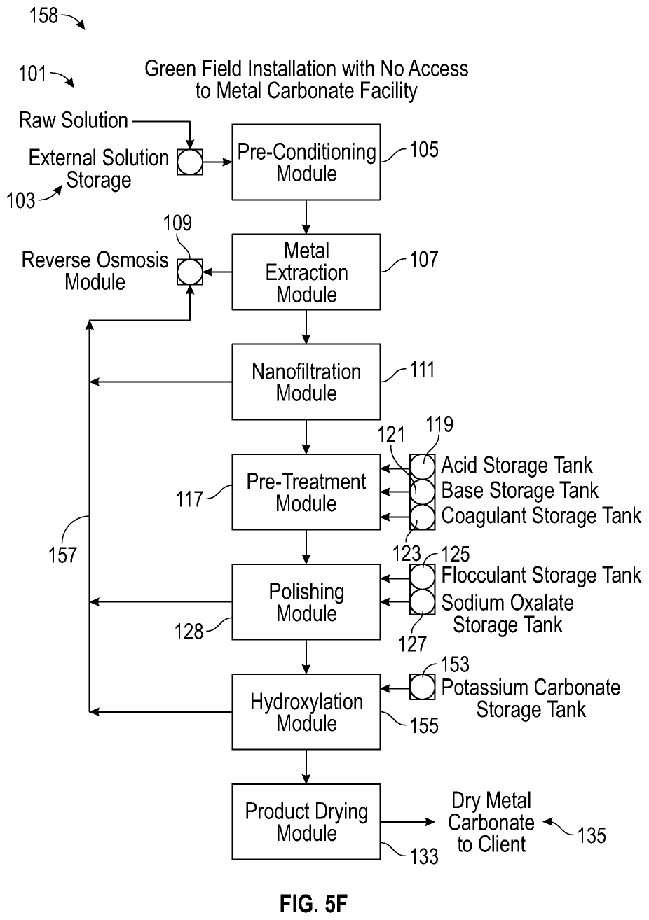

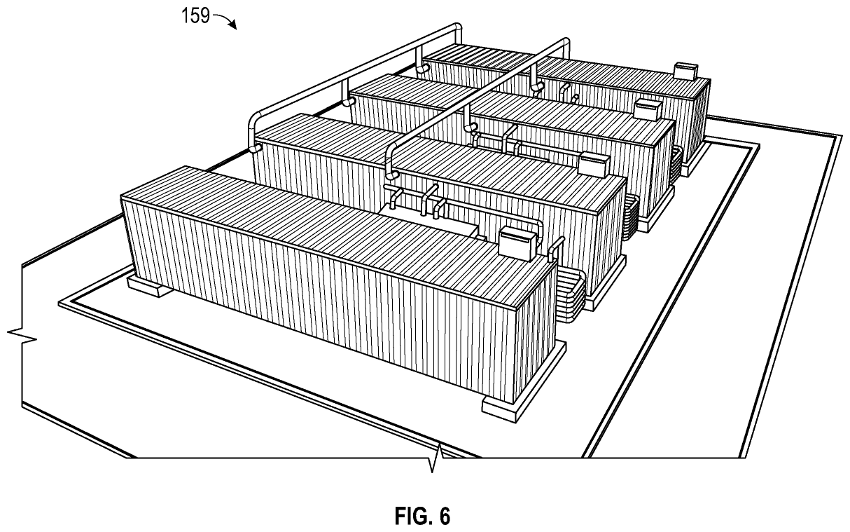

Apparatus 102 depicted in FIG. 5A is a modular apparatus with access to an existing metal carbonate facility comprising nanofiltration module 111. Solution 101 enters an external solution storage tank 103 and enters a pre-conditioning module 105. The solution is transferred to metal extraction module 107 and then to nanofiltration module 111. The solution is transferred to external tank 113, which stores concentrated metal solution 115. Reverse osmosis module 109 receives waste from metal extraction module 107 and nanofiltration module 111.

Apparatus 116 depicted in FIG. 5B is a modular apparatus with no access to an existing metal carbonate facility comprising nanofiltration module 111 and carbonation module 129. Solution 101 enters an external solution storage tank 103 and enters a pre-conditioning module 105. The solution is transferred to metal extraction module 107 and then to nanofiltration module 111. The solution is transferred from nanofiltration module 111 to pre-treatment module 117, which receives an acid from storage tank 119, a base from storage tank 121, and a coagulant from storage tank 123. The solution is transferred from pre-treatment module 117 to polishing module 128, which receives a flocculant from storage tank 119, and sodium oxalate from storage tank 121. The solution is subsequently transferred to carbonation module 129, which receives potassium carbonate from storage tank 131. A wet metal product is then transferred to product drying module 133 and supplied as dry metal carbonate product 135. Waste is transferred from metal extraction module 107, nanofiltration module 111, polishing module 128, and carbonation module 129 through conduit 102 to reverse osmosis module 109.

Apparatus 144 depicted in FIG. 5C is a modular apparatus with no access to an existing metal carbonate facility comprising electrodialysis module 145 and carbonation module 129. Solution 101 enters external solution storage tank 103 and enters pre-conditioning module 105. The solution is transferred to metal extraction module 107 and then to electrodialysis module 145. The solution is transferred from electrodialysis module 145 to pre-treatment module 117, which receives an acid from storage tank 119, a base from storage tank 121, and a coagulant from storage tank 123. The solution is transferred from the pre-treatment module 117 to polishing module 128, which receives flocculant from storage tank 119, and sodium oxalate from storage tank 121. The solution is subsequently transferred to carbonation module 129, which receives potassium carbonate from storage tank 131. A wet metal product is then transferred to product drying module 133 and supplied as dry metal carbonate product 135. Waste is transferred from metal extraction module 107, electrodialysis module 145, polishing module 128, and carbonation module 129 through conduit 142 to reverse osmosis module 109.

Apparatus 146 depicted in FIG. 5D is a modular apparatus with access to an existing metal carbonate facility comprising forward osmosis module 147. Solution 101 enters external solution storage tank 103 and enters pre-conditioning module 105. The solution is transferred to metal extraction module 107 and then to forward osmosis module 147. A wet metal product is then transferred to product drying module 133 and supplied as dry metal carbonate product 135. Waste is transferred from metal extraction module 107, forward osmosis module 147, and product drying module 133 through conduit 149 to reverse osmosis module 109.

Apparatus 150 depicted in FIG. 5E is a modular apparatus with no access to an existing metal carbonate facility, the modular system comprising electrodialysis module 145 and hydroxylation module 155. Solution 101 enters external solution storage tank 103 and enters pre-conditioning module 105. The solution is transferred to metal extraction module 107 and then to electrodialysis module 145. The solution is transferred from electrodialysis module 145 to pre-treatment module 117, which receives acid from storage tank 119, a base from storage tank 121, and a coagulant from storage tank 123. The solution is transferred from pre-treatment module 117 to polishing module 128, which receives a flocculant from storage tank 125, and sodium oxalate from storage tank 127. The solution is subsequently transferred to hydroxylation module 155, which receives potassium carbonate from storage tank 153. A wet metal product is then transferred to product drying module 133 and supplied as a dry metal carbonate product 135. Waste is transferred from metal extraction module 107, electrodialysis module 145, polishing module 128, and hydroxylation module 155 through conduit 151 to reverse osmosis module 109.

Apparatus 158 depicted in FIG. 5F is a modular apparatus with no access to an existing metal carbonate facility comprising nanofiltration module 111 and hydroxylation module 155. Solution 101 enters external solution storage tank 103 and enters pre-conditioning module 105. The solution is transferred to metal extraction module 107 and then to electrodialysis module 145. The solution is transferred from nanofiltration module 111 to pre-treatment module 117, which receives an acid from storage tank 119, a base from storage tank 121, and a coagulant from storage tank 123. The solution is transferred from pre-treatment module 117 to polishing module 128, which receives a flocculant from storage tank 125, and sodium oxalate from storage tank 127. The solution is subsequently transferred to hydroxylation module 155, which receives potassium carbonate from storage tank 153. A wet metal product is then transferred to product drying module 133 and supplied as a dry metal carbonate product 135. Waste is transferred from the metal extraction module 107, the electrodialysis module 145, the polishing module 128, and nanofiltration module 111 through conduit 157 to reverse osmosis module 109.

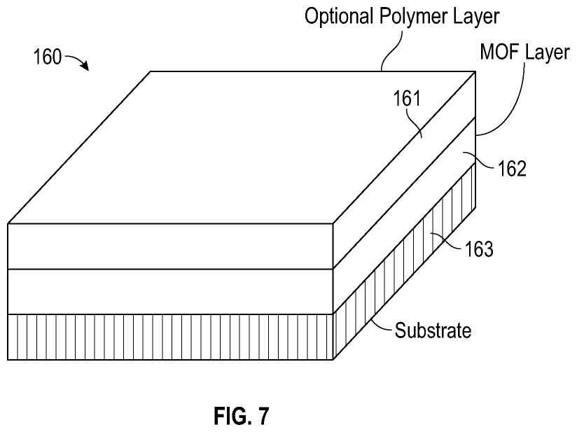

Apparatus 160 depicted in FIG. 7 is a metal-selective membrane in lamellar orientation. Apparatus 160 comprises a flat sheet comprising three layers. The bottom layer comprises a substrate 163, the middle layer comprises an MOF 162, and the top layer comprises an optional polymer layer 161.

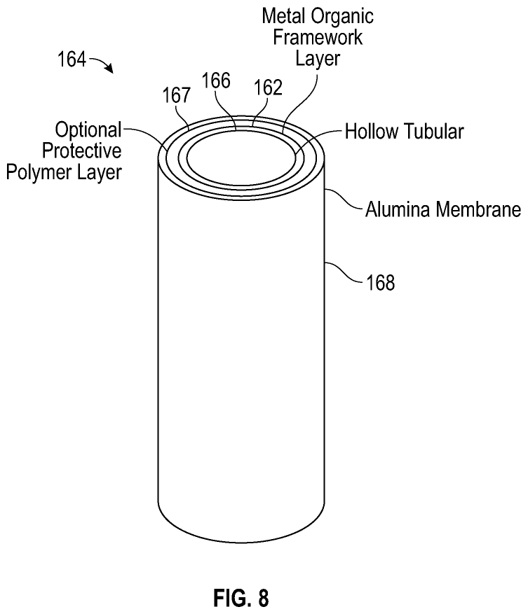

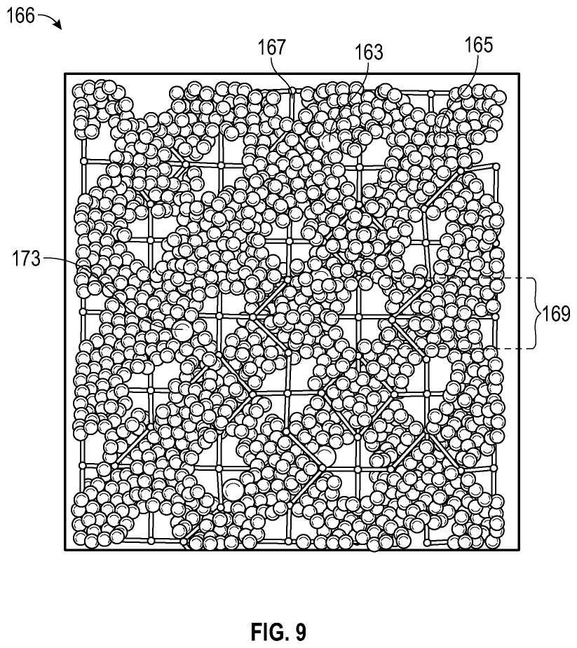

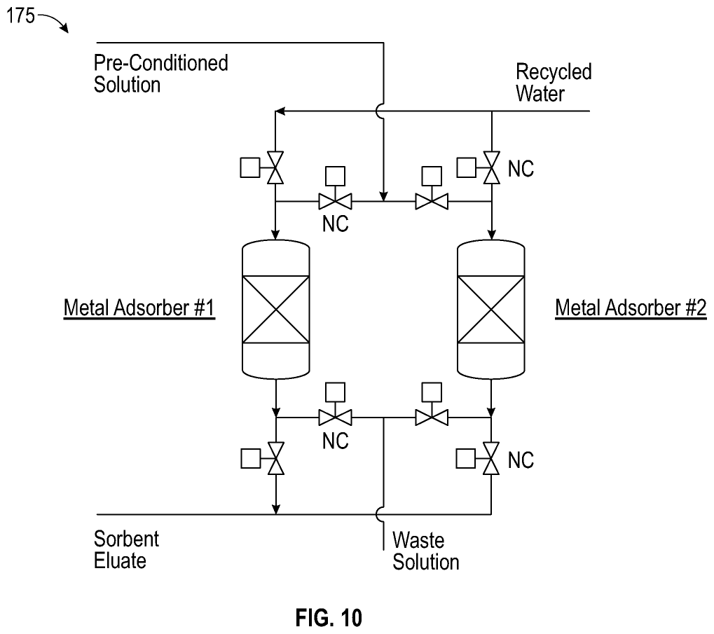

Apparatus 164 depicted in FIG. 8 is a metal-selective membrane in tubular orientation. Apparatus 164 is a flat sheet that comprises three layers around hollow tube 166. The innermost layer comprises MOF 162, the middle layer comprises protective polymer layers 167, and the outermost layer comprises membrane 168 (e.g., alumina membrane).

Apparatus 164 depicted in FIG. 8 is an exemplary metal organic framework (MOF) with embedded ions. MOF 167 forms a support structure for metal ions 173 and non-metal ions 163. The MOF structure may form discrete pores 169 and trap water molecules 165.

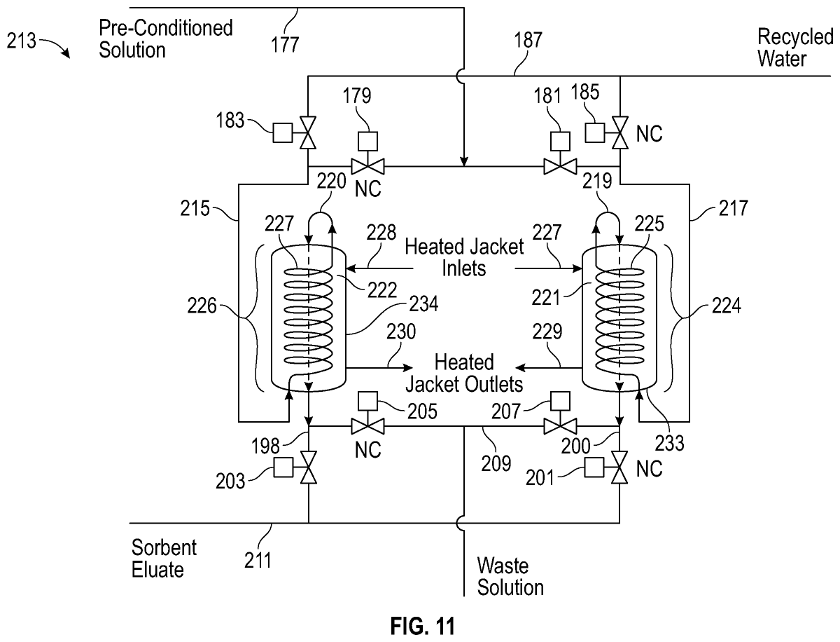

Apparatus 213 depicted in FIG. 11 is an exemplary metal sorption column comprising the column jacket apparatus. Solution enters through conduit 177. Closed valve 179 in communication with conduit 177 stops solution flow into both columns. Open valve 181 in communication with conduit 177 and conduit 217 allows solution to flow into a solution conveyor 225. Backflow from conduit 217 is prevented by valve 185 in communication with conduit 217.

The solution conveyor is at least partially disposed in column jacket space 221 and is encased by first set of inner and outer cylinders 233. Solution leaves the first column jacket apparatus 224 through conduit 219 in communication with solution conveyor 225. Column jacket apparatus 224 is heated though heated column jacket inlet 227 and heated column jacket outlet 229. Column outlet 200 receives solution from the column. Valves 201 and 207 are in communication with column outlet 200 and allow flow to waste outlet 209. Inlet 187 is in communication with valve 183 that allows flow to conduit 215. Valve 179 is in communication with conduit 215 and prevents and/or regulates flow to conduit 217. Second solution conveyor 225′ is in communication with conduit 215 to receive recycled water. Second solution conveyor 227 is at least partially disposed in second column jacket space 222 encased by a second set of inner and out cylinders 234. Solution leaves second column jacket apparatus 226 through conduit 220 in communication with solution conveyor 227. Second column outlet 198 receives solution from the column. Valves 203 and 205 are in communication with column outlet 198 and allow flow to eluate outlet 211.

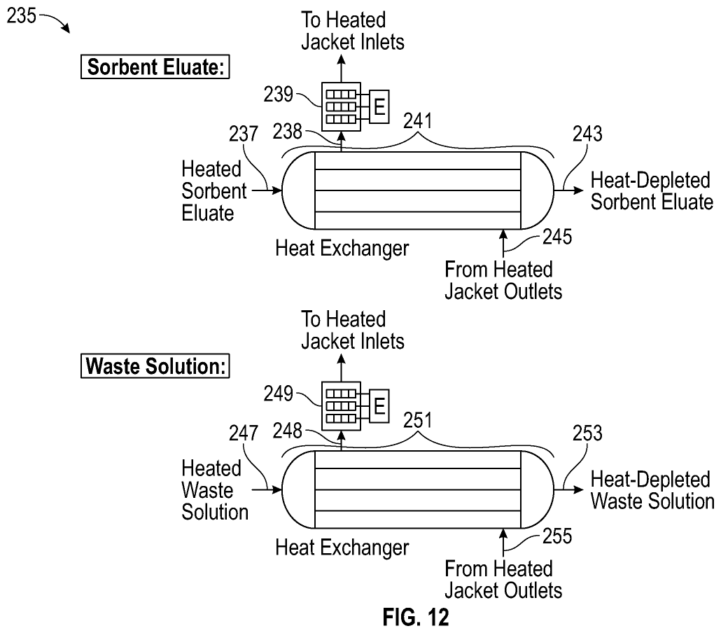

Apparatus 235 depicted in FIG. 12 comprises heat exchangers that may be used to regulate heat in a column jacket apparatus. Heat exchanger 241 receives heated sorbent eluate from inlet 237 and fluid from column jacket apparatus outlets from inlet 245. Heat exchanger expels heat-depleted sorbent eluate from outlet 243 and expels fluid to column jacket apparatus inlets from outlet 238. Heater 239 heats fluid leaving through outlet 238. Heat exchanger 251 receives heated waste solution from inlet 247 and fluid from column jacket apparatus outlets from inlet 255. Heat exchanger expels heat-depleted waste solution from outlet 253 and expels fluid to column jacket apparatus inlets from outlet 248. Heater 249 heats fluid leaving through outlet 248.

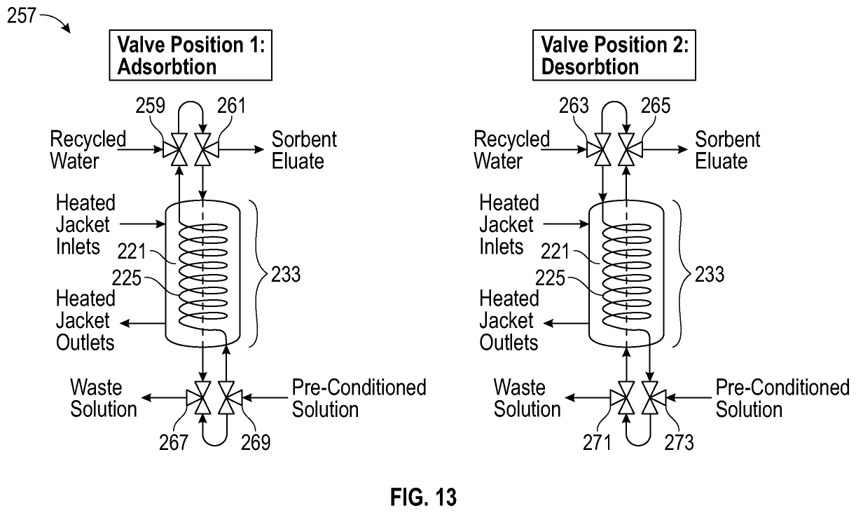

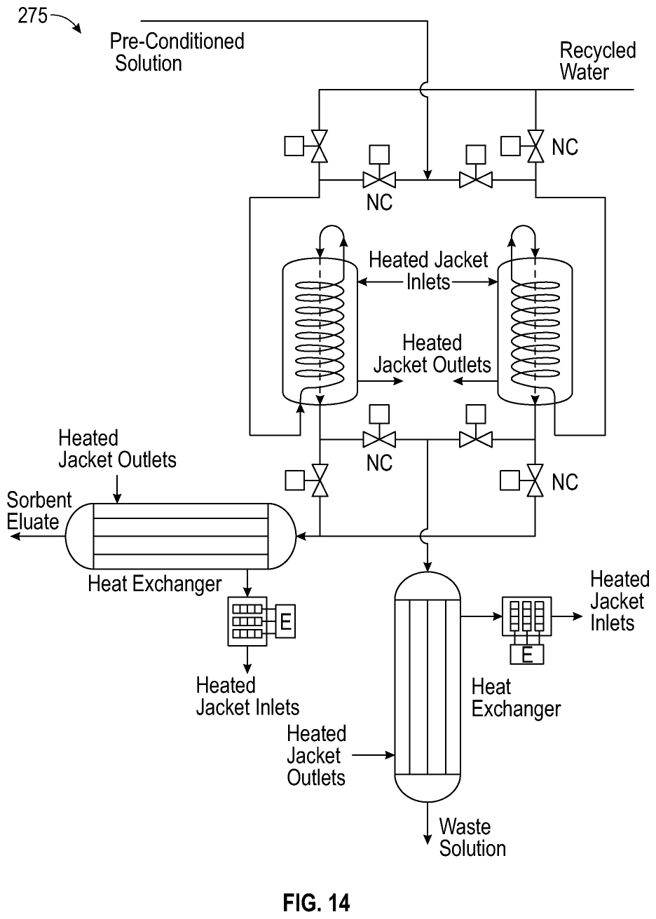

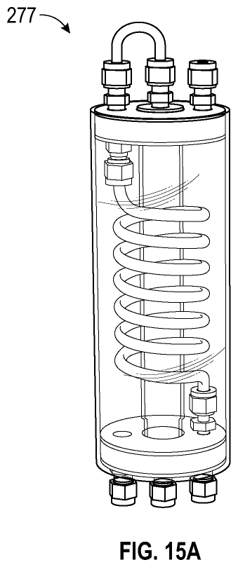

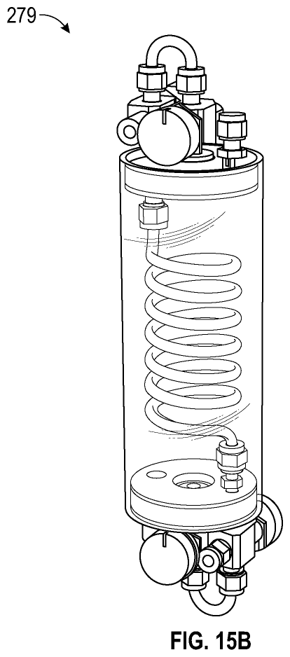

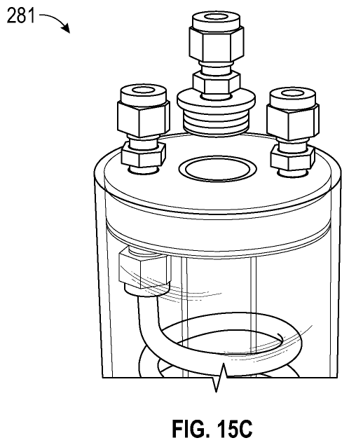

Apparatus 257 depicted in FIG. 13 is an exemplary column jacket apparatus in combination with three-way valves. In valve position one, first three-way valve 269 directs solution to solution conveyor 225, which is at least partially disposed in space 221 of column jacket apparatus 233. Solution conveyor 225 transfers solution to second three-valve 259. Second three-way valve 259 directs solution to third three-way valve 261, which in turn transfers solution to fourth three-way valve 267. Fourth three-way valve 267 also receives solution directed by first three-way valve 269.

In valve position two, first three-way valve 273 directs solution to second three-way valve 271. Second three-way valve 271 directs solution to third three-way valve 265. Third three-way valve 265 directs fluid to fourth three-way valve 263. Fourth three-way valve directs solution to fluid conveyor 225, which is at least partially disposed in space 221 of column jacket apparatus 233. Fluid conveyor transfers solution to first three-way valve 273.

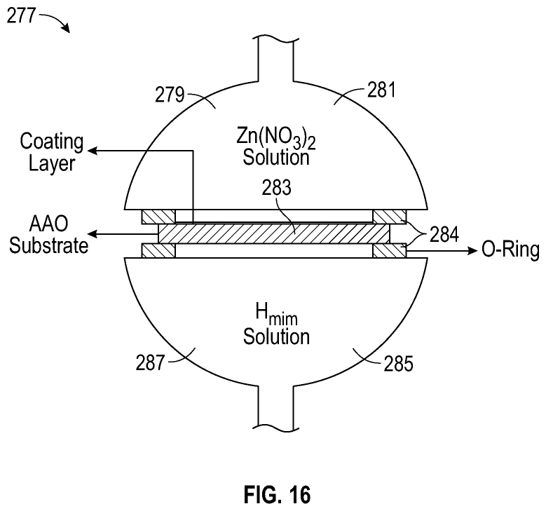

Method 277 depicted in FIG. 16 comprises a method of substrate coating. Substrate 283 is held in place by first frit funnel 281 and second frit funnel 287. The substrate is secured by O-rings 284. Metal precursor solution 279 is poured into first frit funnel 281 and contacts a surface of substrate 283. Linker solution 285 is poured into second frit funnel 287 and contacts a surface of substrate 283.

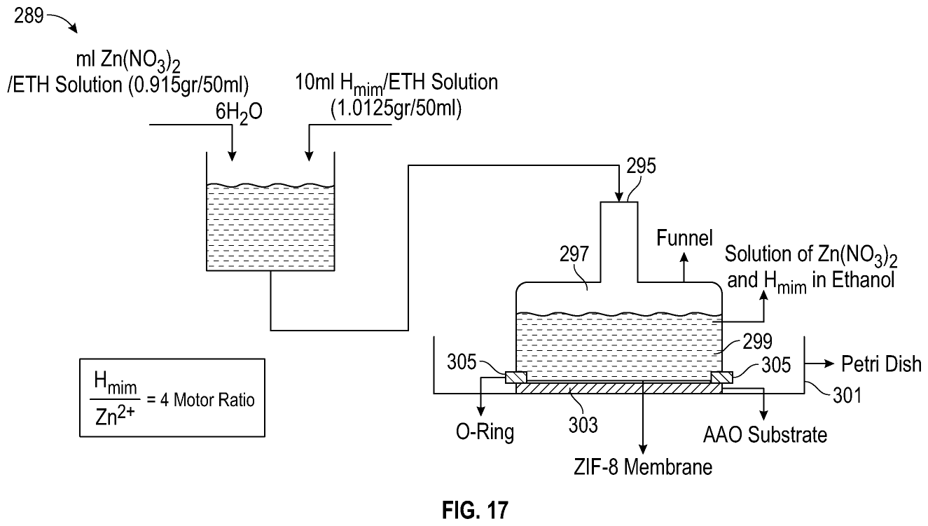

Method 289 depicted in FIG. 17 comprises a method of substrate coating. Substrate 303 is disposed within container 301. Funnel 297 is placed on top of substrate 303. The funnel is secured to the substrate by O-rings 305. Membrane solution 299 is poured through funnel opening 295 and the membrane solution rests on top of the substrate.

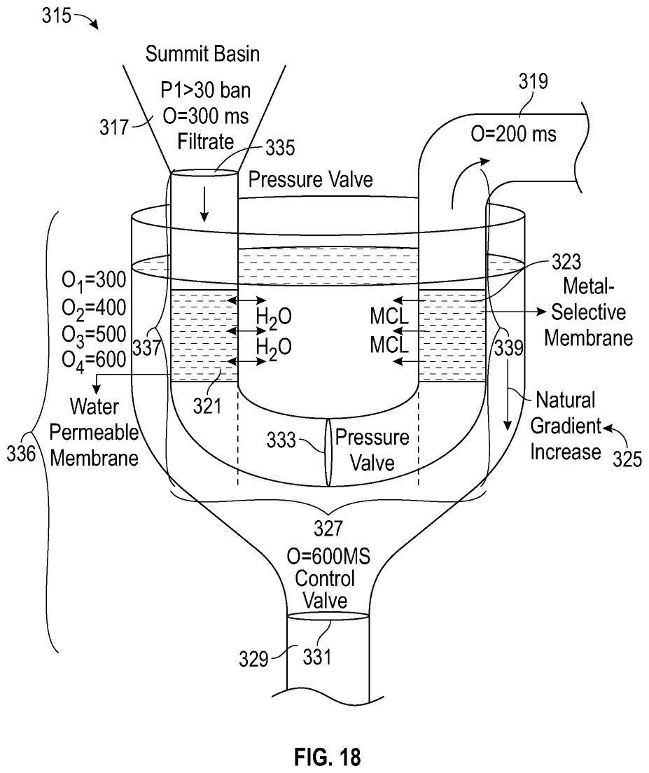

Apparatus 315 depicted in FIG. 18 comprises a loop apparatus for recovering at least one metal from a solution. First loop basin 317 is fitted with first valve 335 and connect to loop 327. The descending limb of loop 337 comprises water-permeable membrane 321. The ascending limb of the loop 339 comprises metal-selective membrane 323 and extends out of second loop basin 336. Second valve 333 is disposed in loop 327 between water-permeable membrane 321 and metal-selective membrane 323. Second loop basin 336 is filled with filtered solution 325. Third valve 331 is fitted to the bottom end of second loop basin 336 and controls flow into basin outlet 329.

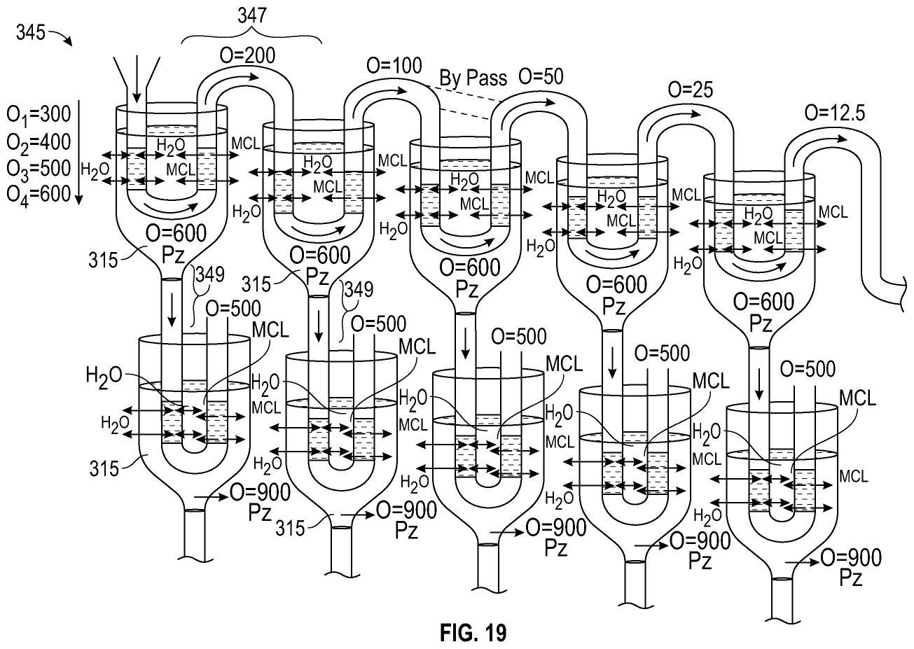

Apparatus 345 depicted in FIG. 19 comprises a loop apparatus cascade. Four individual loop apparatuses 315 are joined by vertical conduits from conical basins 349 and horizontal conduits from loops 347.

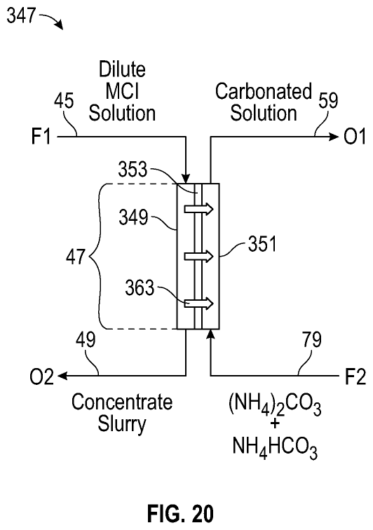

Apparatus 347 depicted in FIG. 20 comprises a forward osmosis system. A solution comprising metal chloride enters through first inlet 45 and enters first chamber 349 of forward osmosis membrane apparatus 47. The metal chloride solution contacts forward osmosis membrane 353 and is driven by osmotic pressure 363 across forward osmosis membrane 353 to second chamber 351. The metal chloride solution is converted to a metal carbonate solution and exits the forward osmosis membrane apparatus through first outlet 59. Carbonate reagents are replaced by second inlet 79, and waste is removed through second outlet 49.

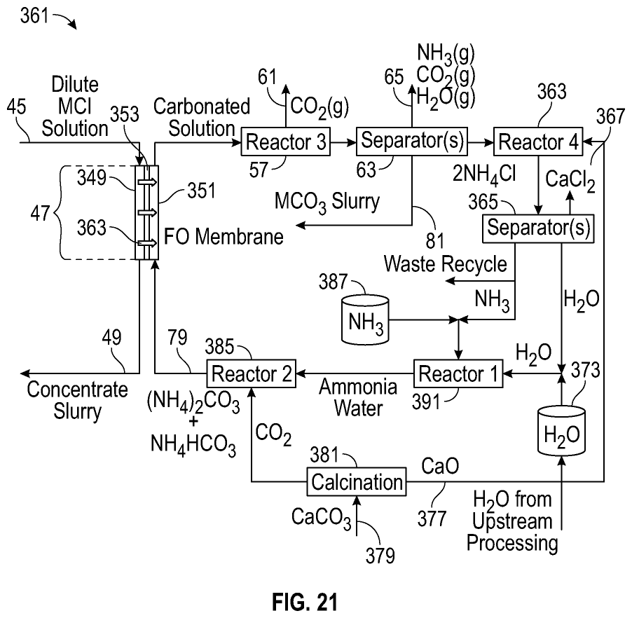

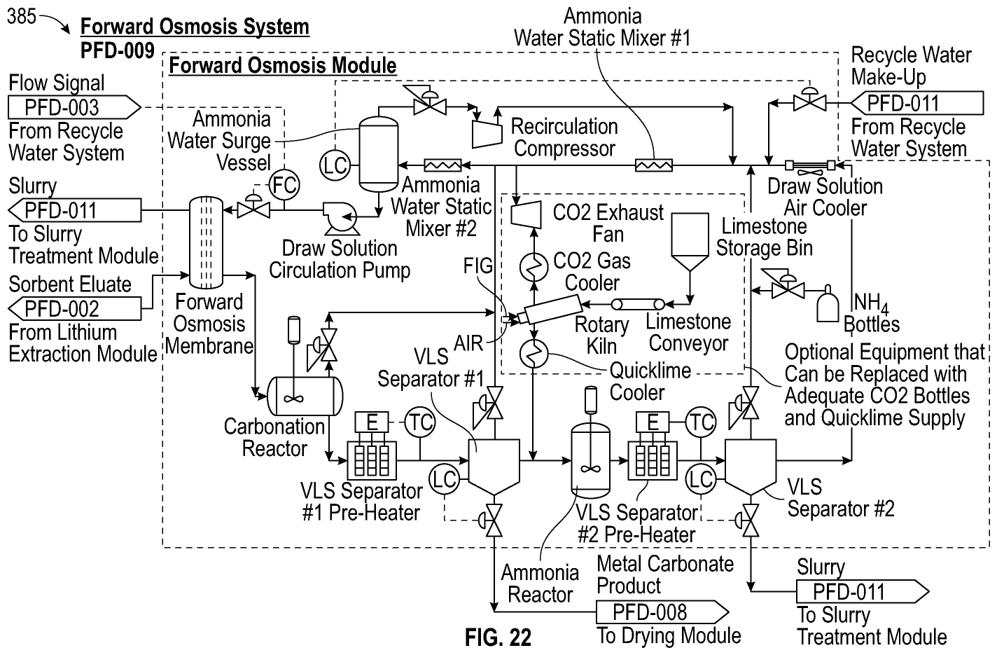

Apparatus 361 depicted in FIG. 21 comprises a forward osmosis and recycle system. A solution comprising metal chloride enters through first inlet 45 and enters first chamber 349 of forward osmosis membrane apparatus 47. The metal chloride solution contacts forward osmosis membrane 353 and is driven by osmotic pressure 363 across forward osmosis membrane 353 to second chamber 351. The metal chloride solution is converted to a metal carbonate solution and exits the forward osmosis membrane apparatus through first outlet 59. Carbonate reagents are replaced by second inlet 79, and waste is removed through second outlet 49. First reactor 57 receives a metal chloride solution from forward osmosis membrane apparatus 47 and completes the conversion of metal chlorides to metal carbonates. Reactor 57 releases CO2 61 as a waste product. First separator 63 receives the metal carbonate solution from first reactor 57 and generates metal carbonate slurry 81 as product and ammonia, carbon dioxide, and water 65 as waste. Second reactor 363 receives and chemically converts 2NH2Cl from first separator 63 to a 2NH3-CaCl2-water solution. A plurality of separator units 365 receive the 2NH3-CaCl2-water solution and generates NH3, CaCl2 and water. CaCl2 is released as waste 367. Water is re-introduced into the system through first conduit 373 and excess NH3 is released through second conduit 387. Third reactor 391 receives NH3 and water from the plurality of separator units 365 and produces ammonia water. Fourth reactor 385 receives ammonia water from third reactor 391 and CO2 from calcination reactor 381. Fourth reactor returns carbonate compounds to second chamber 351 of forward osmosis membrane apparatus 47.

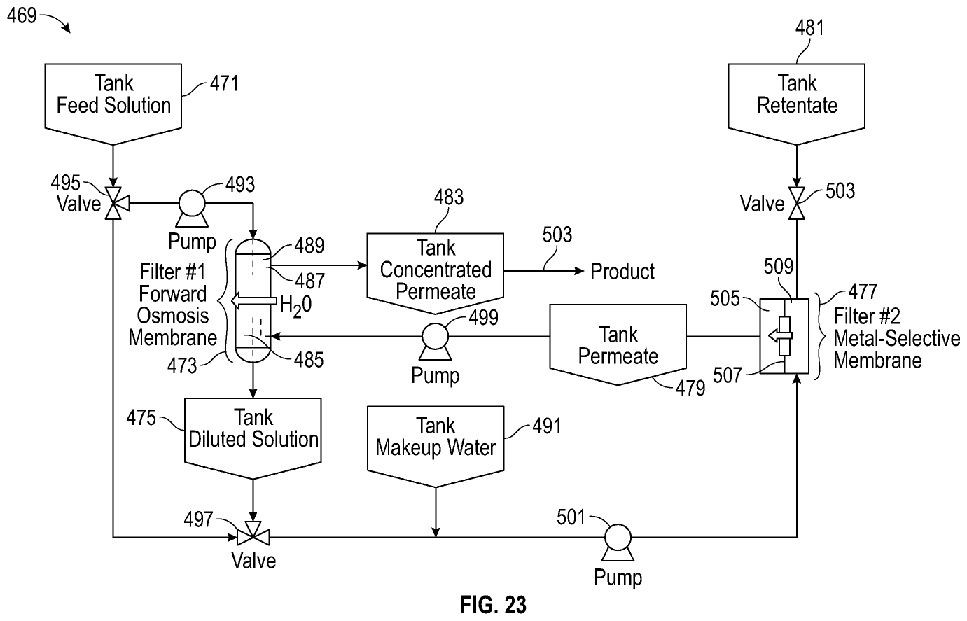

Apparatus 469 depicted in FIG. 23 comprises a system for concentrating metal in a solution. A first solution is conveyed from first tank 471 by first valve 495 and first pump 493 to first filter system 473. First filter system 473 comprises first chamber 485, second chamber 487, and forward osmosis membrane 489. The first solution is at least partially disposed within first chamber 485 and a second solution is at least partially disposed within second chamber 487. The second solution is transported across forward osmosis membrane 489 and mixes with the first solution to produce a third solution. The third solution is conveyed to second tank 475 in communication with second valve 497. Second pump 501 conveys the third solution to second filter system 477. Additional water is added by sixth tank 491 to maintain the fluid balance of system 469 and regulate the solvent concentration of the third solution. The second filter system comprises first chamber 509, second chamber 505 and metal-selective membrane 507. Metal-selective membrane 507 filters the third solution to produce the second solution. Third valve 503 is in communication with the second filter system. Third tank 481 is in communication with third valve 503 and stores waste from the second filter system. Fourth tank 479 is in communication with second filter system 477 and stores the second solution. Third pump 499 conveys the second solution to second chamber 487 to first filter system 473. Fifth thank 483 is in communication with first filter system 473 and product 503 is drawn from fifth tank 483.

The preceding examples can be repeated with similar success by substituting the generically or specifically described components and/or operating conditions of embodiments of the present invention for those used in the preceding examples.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1-70. (canceled)

71. A method of recovering at least one metal from a solution comprising:
contacting the solution with a metal-selective sorbent, wherein the metal selective sorbent is packed in at least one column;
sorbing the at least one metal onto the metal-selective sorbent to form a metal-sorbent complex;
contacting the metal-sorbent complex with an eluant solution to form a metal eluate; and
transporting at least a portion of the metal eluate across a forward osmosis membrane.

72. The method of claim 71 wherein the transporting of at least a portion of the metal eluate across the forward osmosis membrane is driven by an osmotic pressure.

73. The method of claim 71 further comprising contacting the forward osmosis membrane with a draw solution.

74. The method of claim 73 wherein the draw solution comprises a carbonate.

75. The method of claim 73 wherein the draw solution comprises a bicarbonate.

76. The method of claim 71 further comprising converting the metal eluate to a metal carbonate.

77. The method of claim 76 wherein the metal carbonate comprises lithium carbonate.

78. The method of claim 76 further comprising recovering the metal carbonate.

79. The method of claim 78 wherein the metal carbonate is recovered in sufficient quantity to provide a conversion rate of at least about 80%.

80. The method of claim 78 wherein the metal carbonate is recovered at a temperature of at least about 35° C.

81. The method of claim 71 further comprising contacting the metal eluate with a draw solution.

82. The method of claim 81 wherein contacting the metal eluate with a draw solution converts the metal eluate to a metal carbonate.

83. The method of claim 71 further comprising contacting the metal eluate with a metal-selective membrane.

84. An apparatus for recovering at least one metal from a solution, said apparatus comprising:
a first filter system for containing a first solution and a second solution, wherein said first filter system comprises a forward osmosis module comprising a forward osmosis membrane; and
a second filter system for containing said second solution and a third solution, wherein said second filter system comprises a metal-selective membrane.

85. The apparatus of claim 84 wherein said first filter system comprises a first and a second chamber separated by said forward osmosis membrane.

86. The apparatus of claim 84 wherein said second filter system comprises a first and a second chamber separated by said metal-selective membrane.

87. The apparatus of claim 84 wherein said forward osmosis membrane comprises a membrane that is semi-permeable to at least one metal.

88. The apparatus of claim 84 further comprising a selective separation unit.

89. The apparatus of claim 84 further comprising a metal extraction module.

90. The apparatus of claim 84 wherein at least one membrane is selective for lithium.

91. The apparatus of claim 84 wherein said apparatus is at least partially disposed within a shipping container.

92. The apparatus of claim 84 further comprising at least one column.

93. The apparatus of claim 92 further comprising a metal-selective sorbent at least partially disposed within said column.
